(19) United States
(12) Patent Application Publication
(10) Pub. No.: US 2025/0116747 A1
(43) Pub. Date: Apr. 10, 2025

(54) SPARSE BILLBOARD AND T-SHAPED ARRAYS FOR TWO-DIMENSIONAL DIRECTION OF ARRIVAL ESTIMATION

(71) Applicant: KING FAHD UNIVERSITY OF PETROLEUM AND MINERALS, Dhahran (SA)

(72) Inventor: Saleh Ahmed ALAWSH, Dhahran (SA)

(73) Assignee: KING FAHD UNIVERSITY OF PETROLEUM AND MINERALS, Dhahran (SA)

(21) Appl. No.: 18/481,656

(22) Filed: Oct. 5, 2023

(51) Int. Cl. G01S 3/74; G01S 3/14

(52) U.S. Cl. CPC G01S 3/74; G01S 3/143

(57) ABSTRACT

An antenna array for reception of radio waves includes a first leg aligned in a first direction, a second leg aligned in a second direction, a third leg, and a communication module. The elements of the first linear subarray are spaced by a first distance. The elements of the second linear subarray are spaced by a second distance. The first distance is not equal to the second distance. The second direction is orthogonal to the first direction. The third linear subarray is aligned in a third direction that is collinear to the first direction or at an angle of 45 degrees between the first direction and the second direction. The communication module receives the radio waves from the first leg, the second leg and the third leg and determines a two dimensional direction of the source of the radio waves.

### STATEMENT REGARDING PRIOR DISCLOSURE BY THE INVENTORS

Aspects of this technology are described in an article “Sparse Billboard and T-Shaped Arrays for Two-Dimensional Direction of Arrival Estimation”, by S. A. Alawsh, M. H. Mohamed, I. Aboumahmoud, M. Alhassoun and A. H. Muqaibel, published on May 22, 2023, in IEEE Open Journal of Signal Processing, vol. 4, pp. 322-335, 2023, doi: 10.1109/OJSP.2023.3278593.

### STATEMENT OF ACKNOWLEDGEMENT

Financial support provided by the Deanship of Research Oversight and Coordination (DROC), King Fahd University of Petroleum & Minerals (KFUPM) Riyadh, Saudi Arabia through project No. SB191009 is gratefully acknowledged.

### BACKGROUND

### Technical Field

The present disclosure is directed to coprime, nested and supernested sparse billboard and T-shaped arrays for estimation of two-dimensional direction of arrival.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In signal processing, direction of arrival (DOA) denotes a direction from which a propagating wave arrives at a sensor array (a receiving end). DOA estimation is a process of retrieving the directional information of the electromagnetic source(s) by employing processing of signals received by the sensor array. DOA estimation is vital in applications such as communications, signal processing, smart antennas, seismology, acoustics, and radar. The structure of the sensor array plays an essential role in DOA estimation. Many antenna arrays (sensors) are required to achieve greater accuracy in DOA estimation, which is not always feasible due to physical space or cost limitations. An alternative is an array virtualization technique of creating virtual arrays (virtualized arrays), which uses a small number of physical antennas but can estimate DOA using a larger number of created virtual antennas. The array virtualization technique results in relatively good precision in combination with reduced physical array dimensions, decreasing costs and physical space requirements. However, with the virtualization of antenna arrays, there is a possibility of ambiguity in the estimated DOA. An alternative to the array virtualization technique is the use of coprime arrays, which is able to decrease or even eliminate the ambiguity in the DOA estimation.

The antenna array (sensor array) can be classified into a one-dimensional (1D) array, a two-dimensional (2D) array, or a three-dimensional (3D) array. The 2D arrays can jointly estimate the azimuth and elevation of sources. Some well-known 2D array configurations include a uniform rectangular array (URA), a uniform circular array (UCA), a cross-shaped array, an L-shaped array, and a hexagonal array. However, these array configurations usually suffer from significant mutual coupling, resulting in the mutual coupling effect. Hence, linear (1D) sparse arrays, in which the number of sensor pairs with small separations is much smaller than in a uniform linear array (ULA), are more robust to mutual coupling. Examples of linear sparse arrays include minimum redundancy arrays (MRA), nested arrays, coprime arrays, and super nested arrays.

L-shaped nested array have been described. (See: X. Li, S. Ren, J. Liu, and W. Wang, “Augmented L-shaped nested array based on the fourth-order difference co-array concept,” in Proc. IEEE 10th sensor array multichannel signal process. Workshop, 2018, pp. 31-35). However, due to the introduced shift between the two nested subarrays, the array has a largest uniform degrees of freedom (uDOF), requiring the largest aperture.

An hourglass array that has a same number of sensors and the same difference coarray as those in open box arrays (OBA) is known. (See: X. Li, S. Ren, J. Liu, and W. Wang, “Augmented L-shaped nested array based on the fourth-order difference co-array concept,” in Proc. IEEE 10th sensor array multichannel signal process workshop, 2018, pp. 31-35.). However, the hourglass array has a large root mean square error (RMSE) causing a discrepancy between a predicted value and an actual value.

A sparse array configuration also known as super nested array can compute sensor locations for any N (unlike MRAs) and employ a difference coarray. (See: C. L. Liu and P. P. Vaidyanathan, “Super Nested Arrays: Linear Sparse Arrays With Reduced Mutual Coupling-Part I: Fundamentals,” IEEE Trans. Signal Process., vol. 64, no. 16, pp. 4203-4217, 2016.). However, the sparse array configuration fails to provide enhanced degrees of freedom (DOF).

Accordingly, it is one object of the present disclosure to provide coprime, nested and supernested sparse billboard and T-shaped arrays for two-dimensional direction of arrival estimation, in which the antenna arrays have a reduced number of closely separated sensors and realize large degrees of freedom (DOF).

### SUMMARY

In an embodiment, an antenna array for reception of radio waves is described. The antenna array a first leg of antenna elements, wherein the first leg is aligned in a first direction; a second leg of antenna elements, wherein the second leg is aligned in a second direction orthogonal to the first direction; a third leg of antenna elements aligned in a third direction that is one of collinear with the first direction and at an angle of 45 degrees between the first direction and the second direction, wherein the first leg, the second leg and the third leg share a common vertex, and wherein the first leg, the second leg and the third leg are configured to receive the radio waves; wherein each of the first leg, the second leg and the third leg includes: a first linear subarray including N₁ elements separated by a first distance; a second linear subarray including N₂ elements separated by a second distance, wherein the first linear subarray and the second linear subarray are one of a set of coprime arrays, a set of nested arrays and a set of super nested arrays. The antenna array comprises a communication module connected to the first leg, the second leg and the third leg, wherein the communication module comprises a receiver circuitry configured to determine a two dimensional direction of the source of the radio waves.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a block diagram of an antenna array for reception of radio waves, according to aspects of the present disclosure;

FIG. 2A is a schematic representation of sensor locations for a billboard antenna array, according to aspects of the present disclosure;

FIG. 2B is a schematic representation of sensor locations for a T-shaped antenna array, according to aspects of the present disclosure;

FIG. 2C is a schematic representation of sensor locations for a coprime array, according to aspects of the present disclosure;

FIG. 2D is a schematic representation of sensor locations for a nested array, according to aspects of the present disclosure;

FIG. 3A illustrates a fourth-order difference coarray (FODC) representation for a coprime billboard antenna array, according to aspects of the present disclosure;

FIG. 3B illustrates a FODC representation for a coprime T-shaped antenna array, according to aspects of the present disclosure;

FIG. 3C illustrates a FODC representation for a nested billboard antenna array, according to aspects of the present disclosure;

FIG. 3D illustrates a FODC representation for a nested T-shaped antenna array, according to aspects of the present disclosure;

FIG. 3E illustrates a FODC representation for a super nested billboard antenna array, according to aspects of the present disclosure;

FIG. 3F illustrates a FODC representation for a super nested T-shaped antenna array, according to aspects of the present disclosure;

FIG. 4 is an exemplary graph illustrating a relationship of the number of consecutive lags versus the number of physical sensors (N), according to aspects of the present disclosure;

FIG. 5 is an exemplary graph illustrating a relationship of the number of unique lags versus the number of physical sensors (N), according to aspects of the present disclosure;

FIG. 6A is an illustration of true source directions and the corresponding estimated directions for the coprime billboard antenna array, according to aspects of the present disclosure;

FIG. 6B is an illustration of true source directions and the corresponding estimated directions for the nested billboard antenna array, according to aspects of the present disclosure;

FIG. 6C is an illustration of true source directions and the corresponding estimated directions for the super nested billboard antenna array, according to aspects of the present disclosure;

FIG. 6D illustrates a FODC representation for the coprime T-shaped antenna array, according to aspects of the present disclosure;

FIG. 6E illustrates a FODC representation for the nested T-shaped antenna array, according to aspects of the present disclosure;

FIG. 6F illustrates a FODC representation for the super nested T-shaped antenna array, according to aspects of the present disclosure;

FIG. 7A is an exemplary graph illustrating root-mean-squared error (RMSE) of the estimated direction of arrivals (DOAs) without mutual coupling when signal-to-noise ratio (SNR) is varying, according to aspects of the present disclosure;

FIG. 7B is an exemplary graph illustrating the RMSE of the estimated (DOAs) without mutual coupling when SNR is fixed, according to aspects of the present disclosure;

FIG. 8A is an exemplary graph illustrating the RMSE of the estimated DOAs with mutual coupling when SNR is varying, according to aspects of the present disclosure;

FIG. 8B is an exemplary graph illustrating the RMSE of the estimated DOAs with mutual coupling when SNR is fixed, according to aspects of the present disclosure;

FIG. 9 is an exemplary graph illustrating a relationship of RMSE with mutual coupling versus mutual coupling coefficient (c₁), according to aspects of the present disclosure; and

FIG. 10 is an exemplary graph illustrating the RMSE with mutual coupling versus SNR when the number of sources is 25, according to aspects of the present disclosure.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to an antenna array for the reception of radio waves. The present disclosure includes a sparse billboard antenna array and a T-shaped antenna array for two-dimensional direction of arrival (2D-DOA) estimation. In a 2D-DOA estimation, one or more planar arrays estimate the elevation and azimuth angles simultaneously. However, planar array configurations such as billboard, L-shaped, T-shaped, and 2D nested arrays suffer from mutual coupling that results from the small separation between the physical sensors (antennas), which limits the estimation capability of the sensor array. In an attempt to reduce mutual coupling between sensors, the described sparse billboard and T-shaped arrays employ a small number of closely separated sensors. In order to extend a Cramer-Rao bound (CRB) for the spacing of the fourth-order coarray, the present disclosure also provides a plurality of closed-form expressions for the sensor locations and the number of consecutive lags and for the uniform degrees of freedom (uDOF). In estimation theory and statistics, the Cramer-Rao bound (CRB) defines a lower bound on the variances of unbiased estimates of parameters, e.g., directions of arrival (DOA) in array processing. Closed-form expressions for the CRB offer insights into the dependence of the array performance with respect to various parameters such as the number of sensors N in the array, the array geometry, the number of sources D, the number of snapshots, signal to noise ratio (SNR), and the like.

DOA estimation and beamforming are two important aspects in the field of signal processing. DOA estimation refers to the process of determining the direction of arrival of a signal, which is useful in various applications such as target tracking, radar systems, and wireless communication. Beamforming is a technique used to create a directional beam by combining the signals from multiple antennas, thereby improving signal quality and allowing for better signal reception or transmission in specific directions. Together, DOA estimation and beamforming play a significant role in enhancing the performance and reliability of communication systems. For example, in a communication system, the signal is broadcast by a transmitter and received by a receiver having one or more receiver arrays. For example, two receiver arrays can be configured to receive the transmitted signals. The two receiver arrays can be separated from each other. It is necessary for the receiver to find the exact location of the transmitter using DOA so that the receiver arrays and the transmitter can be aligned to perform efficient data transmission. The receiver arrays are able to resolve the received signal by correlating their received signals. Each receiver array identifies lags in the signals, which are filled in by interpolation by processing circuitry. It is required that the receiver arrays have minimum mutual coupling; thereby, a coprime array is introduced. The coprime array includes a coprime pair of uniform linear subarrays (ULAs) with inter-element spacing larger than half a wavelength. The ULA antenna is a type of antenna composed of a linear arrangement of identical antenna elements. These elements are usually equidistant from each other and connected in phase and amplitude to achieve the desired radiation pattern. The coprime arrays achieve higher DOFs than the number of physical sensors, and there is no mutual coupling problem.

The antennas used in the antenna arrays are not limited and may be any wireless antenna or wireless sensor. Examples of wireless antennas and sensors are dipole antennas, directional antennas, monopole antennas, small loop, large loop and halo antennas, sector antennas, helical antennas Yagi-Uda antennas, horn antennas, Vivaldi antennas, aperture antennas, internet of things (IoT) sensors, and the like.

In various aspects of the disclosure, definitions of one or more terms that will be used in the document are provided below.

The term “coprime arrays” is defined as a pair of subarrays where no two elements have a common factor greater than 1. In other words, the greatest common divisor of any two elements in the coprime array is 1. The coprime arrays allow for more efficient calculations by avoiding common factors.

The term “fourth-order difference coarray” refers to an arrangement of antenna elements in a coarray structure, where a spacing between adjacent elements is increased by a factor of four. A fourth-order difference coarray configuration helps improve the resolution and directionality of the antenna system. By utilizing a fourth-order difference coarray, an antenna system can detect and resolve smaller signals and perform improved beamforming and spatial filtering.

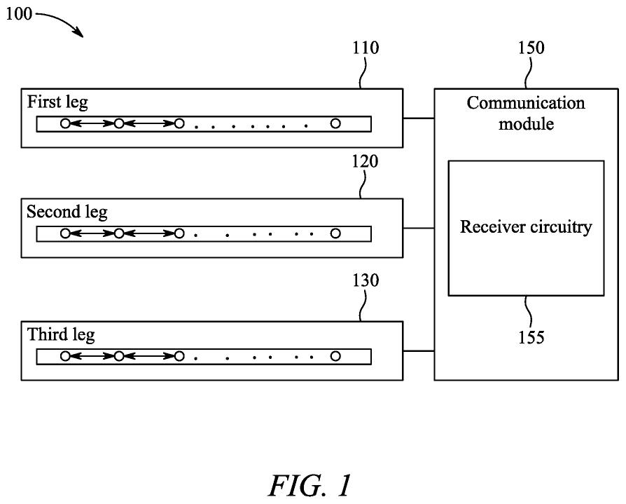

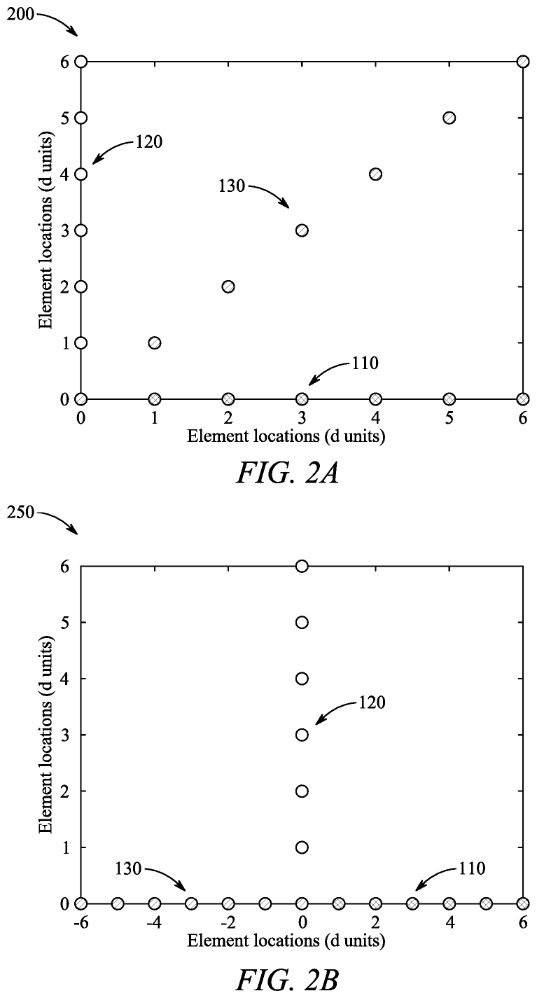

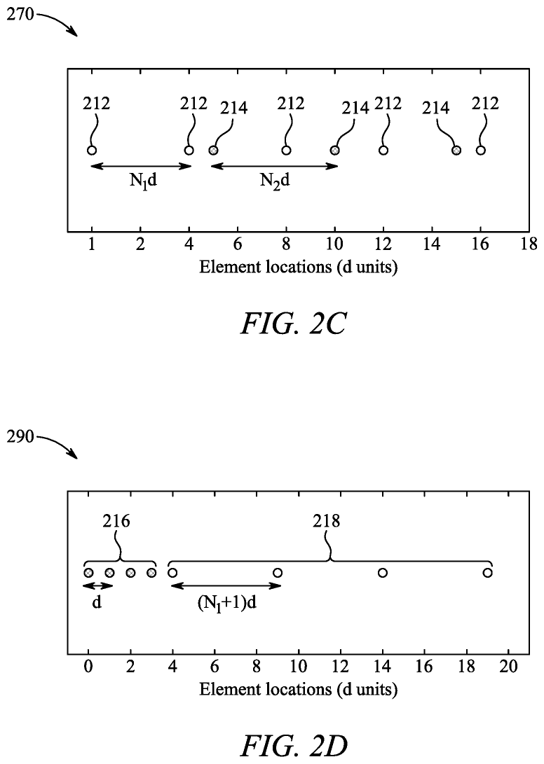

FIG. 1 illustrates a block diagram of an antenna array 100 for reception of radio waves, according to aspects of the present disclosure. The antenna array 100 includes a first leg 110, a second leg 120, a third leg 130, and a communication module 150. Each of the first leg 110, the second leg 120 and the third leg 130 comprise a first linear subarray which has N₁ antenna elements (or sensors) separated by a first distance and a second linear subarray which has N₂ antenna elements (or sensors) separated by a second distance (See FIG. 2C and FIG. 2D). The total number N of elements in the antenna array is greater than or equal to 11 and less than or equal to 1000. The first leg 110 is aligned in a first direction. The second leg 120 is aligned in a second direction that is orthogonal to the first direction. The third leg 130 is aligned in a third direction that is one of collinear to the first direction and at an angle of 45 degrees between the first direction and the second direction. The first leg 110, the second leg 120 and the third leg 130 comprise one of a set of coprime arrays, a set of nested arrays and a set of super nested arrays. The first leg 110, the second leg 120 and the third leg 130 are configured to receive the radio waves from a source (transmitter).

The communication module 150 is connected to the first leg 110, the second leg 120 and the third leg 130. The communication module 150 includes receiver circuitry 155. The receiver circuitry 155 is configured to receive the radio waves from the antennas of the first leg 110, the second leg 120 and the third leg 130 and determine a two dimensional direction of the source of the radio waves. The determined two dimensional direction is used to determine the location of the source of the radio waves, which information may be used in downstream processing, such as beamforming, to adjust the angles of the antenna arrays or their reception directions to modify the antennas or their reception parameters to focus on the direction of the source of the radio waves.

In an aspect, the receiver circuitry 155 includes a memory and a processor. The receiver circuitry 155 is configured to employ preprocessing on the received data, such as filtering and amplifying the received data. The memory is configured to store preprocessed data and computer-readable program instructions for determining the two dimensional direction. The memory may include any computer-readable medium known in the art including, for example, volatile memory, such as Static Random Access Memory (SRAM) and Dynamic Random Access Memory (DRAM) and/or nonvolatile memory, such as Read Only Memory (ROM), erasable programmable ROM, flash memories, hard disks, optical disks, and magnetic tapes.

The processor is configured to fetch and execute the computer-readable program instructions stored in the memory. The processor is configured to execute a sequence of machine-readable instructions, which may be embodied in a program or software. The instructions can be directed to the processor, which may subsequently execute the instructions to implement the methods of the present disclosure. The processor may be implemented as one or more microprocessors, microcomputers, microcontrollers, digital signal processors, central processing units, state machines, logic circuitries, and/or any devices that manipulate signals based on operational instructions.

In a structural aspect, a minimum separation distance d between the antenna elements of the first leg 110, the second leg 120 and the third leg 130 is equal to one half of a minimum radio wavelength measurable by the antenna elements.

In the present disclosure, six different 2D antenna arrays are derived from the billboard and T-shaped arrays. Each 2D antenna array is constructed using three identical one dimensional (1D) sparse arrays, wherein the 1D sparse array is chosen from any of a coprime array configuration, a nested array configuration, and a super nested array configuration. In aspects of the present disclosure, the antenna array 100 may be a coprime billboard antenna array, a nested billboard antenna array, a super nested billboard antenna array, a coprime T-shaped antenna array, a nested T-shaped antenna array, or a super nested T-shaped antenna array.

The six 2D antenna array configurations achieve large degrees of freedom (DOF) when the fourth-order difference coarray (FODC) is exploited. DOF is defined as a measure of the maximum number of sources that can be concurrently estimated. The six 2D arrays employ closed-form sensor locations and have closed formulas for the number of consecutive lags. The T-shaped antenna arrays result in a higher DOF as compared with the billboard antenna arrays. Among the six antenna arrays, the four antenna arrays based on the coprime arrays and the super nested arrays offer significantly reduced values for the smallest weights in the 2D weight function of the FODC. During experimentation, the antenna arrays were stimulated in MATLAB to validate the results. The results confirmed the robustness of the antenna arrays in the presence of mutual coupling.

As illustrated in FIG. 2A, a billboard antenna 200 is shown in which the third leg 130 is aligned in the third direction, which is at an angle of 45 degrees between the antenna elements of the first leg 110 extending in the first direction along the X-axis and the antenna elements of the second leg 120 extending in the second direction along the Y-axis.

As illustrated in FIG. 2B, a T-shaped antenna array 250 is shown in which the third leg 130 is aligned in a third direction along the negative X axis that is collinear with and opposite in direction to the antenna elements of the first leg 110 extending in the first direction along the positive X axis and orthogonal to the antenna elements of the second leg 120 extending in the second direction along the Y axis.

As shown in FIG. 2C, a coprime array 270 is composed of a first linear subarray, having N₁ antenna elements 214 spaced by N₂d and a second linear subarray having N₂ antenna elements 212 spaced by N_{1d}, where N₂>N₁.

As shown in FIG. 2D, a nested array 290 is composed of a first linear subarray, having N₁ antenna elements 216 spaced by d and a second linear subarray having N₂ antenna elements 218 spaced by (N₁+1)d.

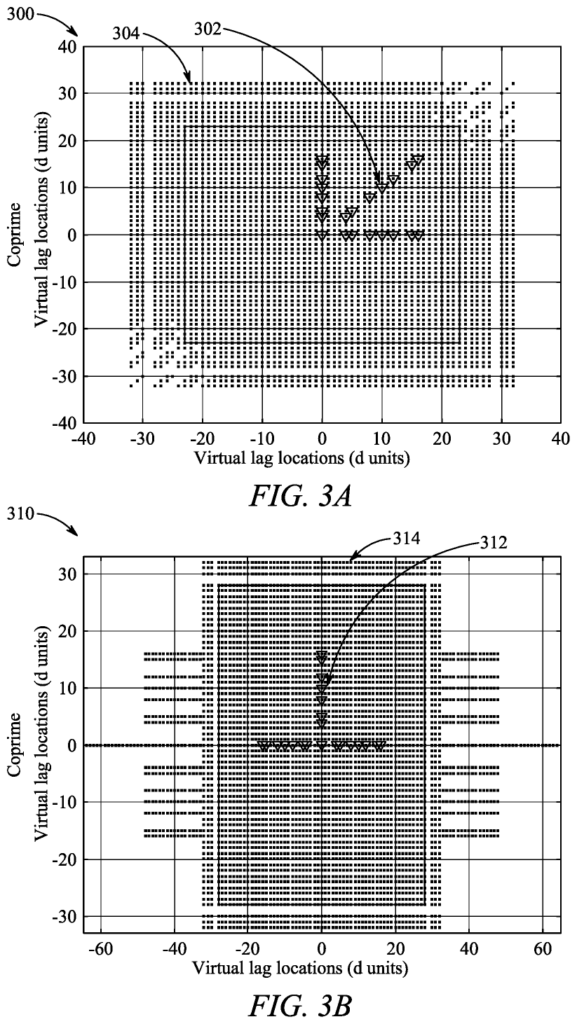

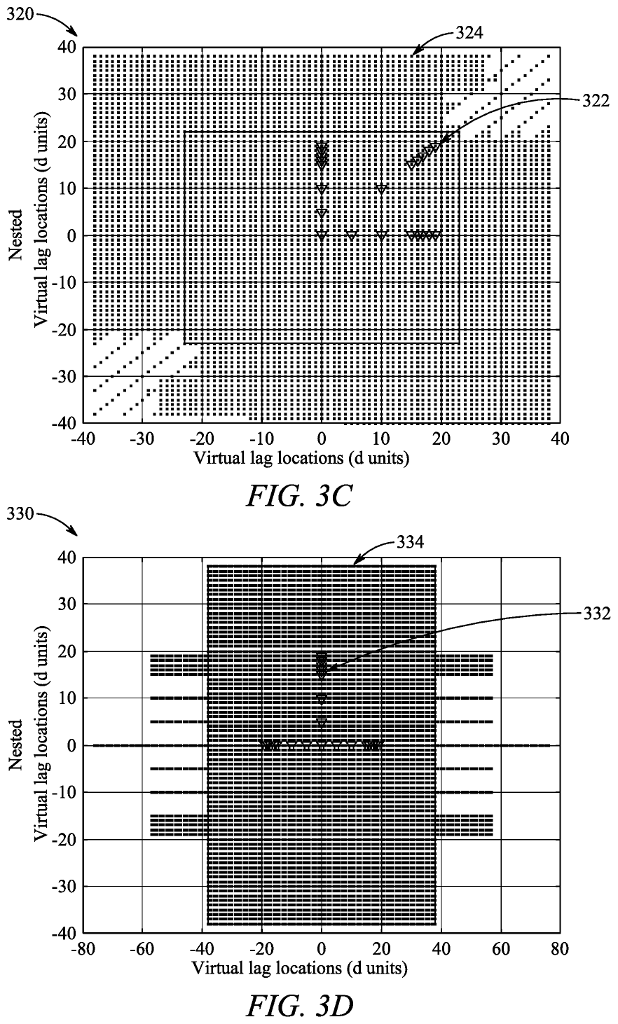

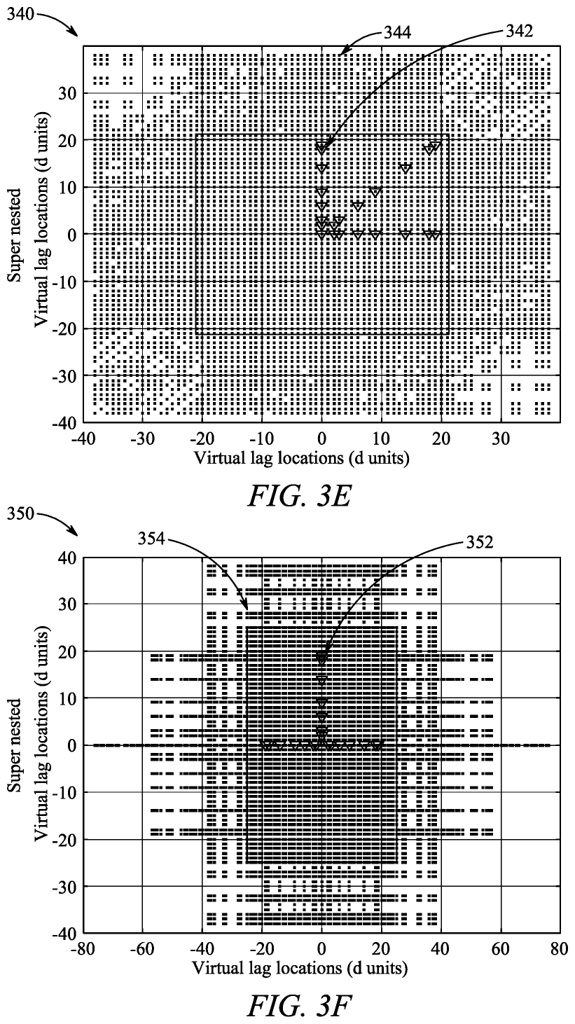

In the coprime billboard antenna array shown in FIG. 3A, the third leg 130 is aligned in the third direction, which is at an angle of 45 degrees between the first direction and the second direction as shown in the coprime linear subarray of FIG. 2A. Each leg of the coprime billboard antenna array is comprised of a coprime linear subarray having antenna elements 302. The first linear subarray is coprime with the second linear subarray, where N₂>N₁. The first distance is equal to N₂d and the second distance is equal to N₁d. For the coprime billboard antenna array, the aperture size is given by: (N₁(N₂−1) times N₁(N₂−1)). A total number N of antenna elements in the coprime billboard antenna array is given by: N=3(N₁+N₂−1)−2.

The maximum uniform number of degrees of freedom (uDOF) of the coprime billboard antenna array is given by:

$${( 2 ( {N}_{1} {N}_{2} + {N}_{1} ) - 1 )}^{2} for 2 {N}_{1} > {N}_{2} and {N}_{1} > 2 , and$$

$${( 2 ( {N}_{1} {N}_{2} - {N}_{1} + {N}_{2} ) - 1 )}^{2} for 2 {N}_{1} < {N}_{2} .$$

In the coprime T-shaped antenna array shown in FIG. 3B, the third leg 130 (see FIG. 2B) is aligned in a third direction that is collinear with and opposite in direction to the first direction. As shown in FIG. 2C, each leg is a coprime linear subarray having antenna elements 312. The first linear subarray is coprime with the second linear subarray, wherein N₂>N₁. The first distance between the N₁ antenna elements 214 is equal to N₂d and the second distance between the N₂ antenna elements 212 is equal to N₁d. For the coprime T-shaped antenna array, the aperture size of is given by: ((2(N₁+(N₂−1)(N₁+1)) times (N₁+(N₂−1)(N₁+1))), and the total number N of antenna elements in the coprime T-shaped antenna array is given by: N=3(N₁+N₂−1)−2.

The maximum uniform number of degrees of freedom (uDOF) of the coprime T-shaped antenna array is given by:

$${( 6 {N}_{2} - 1 )}^{2} for {N}_{1} = 2$$

$$and$$

$${( 2 ( {N}_{1} {N}_{2} + {N}_{1} + {N}_{2} ) - 1 )}^{2} for {N}_{1} > 2 .$$

FIG. 3C depicts the first leg and the second leg of a nested billboard antenna array in which the third leg 130 (see FIG. 2A) is aligned in the third direction that is at an angle of 45 degrees between the first direction and the second direction. Each linear subarray of the nested billboard antenna array is a nested array having antenna elements 322. The first distance is equal to d, and the second distance is equal to (N₁+1)d.

In the nested billboard antenna array, the aperture size is equal to: ((N₁+(N₂−1) (N₁+1) times (N₁+(N₂−1) (N₁+1)). The total number N of antenna elements in the nested billboard antenna array is given by: N=3(N₁+N₂)−2. Also, the maximum uniform number of degrees of freedom (uDOF) of the nested billboard antenna array is given by: (2(N₁N₂+N₁+N₂)−1)² for all N₁, N₂.

FIG. 3D depicts the first leg and the second leg of a nested T-shaped antenna array in which the third leg 130 (shown in FIG. 2B) is aligned in a third direction that is collinear with and opposite in direction to the first direction, wherein the first distance is equal to d, and the second distance is equal to (N₁+1)d. Each leg of the nested T-shaped antenna array comprises a nested array.

For the nested T-shaped antenna array, the aperture size is equal to: ((2(N₁+(N₂−1) (N₁+1) times (N₁+(N₂−1) (N₁+1))), and the total number N of antenna elements in the nested T-shaped antenna array is given by: N=3(N₁+N₂)−2.

The maximum uniform number of degrees of freedom (uDOF) of the nested T-shaped antenna array is given by: (4(N₁N₂+N₂)−3)² for all N₁, N₂.

The billboard antenna array shown in FIG. 2A may have a first linear subarray and a second linear subarray which are super nested, as shown by antenna elements 342 of FIG. 3E. In this configuration, the third leg 130 is aligned in a third direction that is at an angle of 45 degrees between the first direction and the second direction. Each leg of the super nested billboard antenna array comprises a super nested array with N₁≥4, N₂≥3. The elements 342 of the supernested array are specified by an integer set S² defined by:

$${S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {Z}_{1}^{( 2 )} ⋃ {Z}_{2}^{( 2 )} ,$$

$${X}_{1}^{( 2 )} = \{ 1 + 2 l \vert 0 \leq l \leq {A}_{1} \} ,$$

$${Y}_{1}^{( 2 )} = \{ ( {N}_{1} + 1 ) - ( 1 + 2 l ) \vert 0 \leq l \leq {B}_{1} \} ,$$

$${X}_{2}^{( 2 )} = \{ ( {N}_{1} + 1 ) + ( 2 + 2 l ) \vert 0 \leq l \leq {A}_{2} \} ,$$

$${Y}_{2}^{( 2 )} = \{ 2 ( {N}_{1} + 1 ) - ( 2 + 2 l ) \vert 0 \leq l \leq {B}_{2} \} ,$$

$${Z}_{1}^{( 2 )} = \{ l ( {N}_{1} + 1 ) \vert 2 \leq l \leq {N}_{2} \} ,$$

$${Z}_{2}^{( 2 )} = \{ {N}_{2} ( {N}_{1} + 1 ) - 1 \} ,$$

where l is the dipole length of each of the antennas and the parameters A₁, B₁, A₂, and B₂ are defined as:

$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r , r - 2 ) , & if {N}_{1} = 4 r + 2 \\ ( r , r , r , r - 1 ) , & if {N}_{1} = 4 r + 3\end{matrix}$$

where r is an integer which can be selected according to design parameters.

For the super nested billboard antenna array, the aperture size is equal to: (((N₁+(N₂−1) (N₁+1) times (N₁+(N₂−1) (N₁+1))). The total number N of antenna elements in the super nested billboard antenna array is given by: N=3(N₁+N₂)−2.

The maximum uniform number of degrees of freedom (uDOF) of the super nested billboard antenna array is given by:

$${( 2 ( {N}_{1} {N}_{2} + 2 {N}_{1} ) - 1 )}^{2} for {N}_{1} , {N}_{2} : even , \frac{{N}_{1}}{2} , \frac{{N}_{2}}{2} : odd ,$$

$${( 2 ( {N}_{1} {N}_{2} + \frac{3}{2} {N}_{1} ) - 1 )}^{2} for {N}_{1} , {N}_{2} , \frac{{N}_{1}}{2} , \frac{{N}_{2}}{2} : even ,$$

$${( 2 ( {N}_{1} {N}_{2} + {N}_{1} ) + 1 )}^{2} for {N}_{1} , {N}_{2} : odd ,$$

$${( 2 ( {N}_{1} {N}_{2} + {N}_{1} ) + 1 )}^{2} {N}_{1} : odd , {N}_{2} , \frac{{N}_{1}}{2} , \frac{{N}_{2}}{2} : even ,$$

$${( 2 ( {N}_{1} {N}_{2} + {N}_{1} ) + 1 )}^{2} for {N}_{1} , \frac{{N}_{2}}{2} : odd , {N}_{2} : even ,$$

$${( 2 ( {N}_{1} {N}_{2} + \frac{3}{2} {N}_{1} ) + 1 )}^{2} for {N}_{1} , \frac{{N}_{1}}{2} : even , {N}_{2} : odd , and$$

$${( 2 ( {N}_{1} {N}_{2} + 2 {N}_{1} ) + 1 )}^{2} for {N}_{1} : even , \frac{{N}_{1}}{2} , {N}_{2} : odd .$$

FIG. 3F depicts a super nested T-shaped antenna array in which the third leg 130 is aligned in the third direction that is collinear with and opposite in direction to the first direction, wherein N₁≥4, N₂≥3. Each leg of the super nested billboard antenna array comprises a super nested array with N₁≥4, N₂≥3. The first linear subarray has a spacing between antenna elements 352 of d. The second linear subarray of the supernested billboard antenna is specified by an integer set S² defined by:

$${S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {Z}_{1}^{( 2 )} ⋃ {Z}_{2}^{( 2 )} ,$$

$${X}_{1}^{( 2 )} = \{ 1 + 2 l \vert 0 \leq l \leq {A}_{1} \} ,$$

$${Y}_{1}^{( 2 )} = \{ ( {N}_{1} + 1 ) - ( 1 + 2 l ) \vert 0 \leq l \leq {B}_{1} \} ,$$

$${X}_{2}^{( 2 )} = \{ ( {N}_{1} + 1 ) + ( 2 + 2 l ) \vert 0 \leq l \leq {A}_{2} \} ,$$

$${Y}_{2}^{( 2 )} = \{ 2 ( {N}_{1} + 1 ) - ( 2 + 2 l ) \vert 0 \leq l \leq {B}_{2} \} ,$$

$${Z}_{1}^{( 2 )} = \{ l ( {N}_{1} + 1 ) \vert 2 \leq l \leq {N}_{2} \} ,$$

$${Z}_{2}^{( 2 )} = \{ {N}_{2} ( {N}_{1} + 1 ) - 1 \} ,$$

where l is an integer related to the dipole length of each of the antenna elements and A₁, B₁, A₂, and B₂ are parameters defined as:

$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r , r - 2 ) , & if {N}_{1} = 4 r + 2 \\ ( r , r , r , r - 1 ) , & if {N}_{1} = 4 r + 3\end{matrix}$$

where r is an integer which can be selected according to design parameters.

When the antenna array is a super nested T-shaped antenna array, the aperture size is equal to: (2(N₁+(N₂−1) (N₁+1) times (N₁+(N₂−1) (N₁+1)). The total number N of antenna elements in the super nested T-shaped antenna array is given by: N=3(N₁+N₂)−2.

The maximum uniform number of degrees of freedom (uDOF) of the super nested T-shaped antenna array is given by:

$${( 2 ( {N}_{1} {N}_{2} + \frac{5}{2} {N}_{1} ) - 1 )}^{2} for {N}_{1} , {N}_{2} , \frac{{N}_{1}}{2} , \frac{{N}_{2}}{2} : even ,$$

$${( 2 ( {N}_{1} {N}_{2} + 2 {N}_{1} ) + {N}_{2} )}^{2} for {N}_{1} , {N}_{2} : even , \frac{{N}_{1}}{2} , \frac{{N}_{2}}{2} : odd ,$$

$${( 2 ( {N}_{1} {N}_{2} + 2 {N}_{1} ) + {N}_{2} + 2 )}^{2} for {N}_{1} : even , \frac{{N}_{1}}{2} , {N}_{2} : odd ,$$

$${( 2 ( {N}_{1} {N}_{2} + {N}_{1} + {N}_{2} ) + 1 )}^{2} for {N}_{1} , {N}_{2} : odd ,$$

$${( 2 ( {N}_{1} {N}_{2} + {N}_{1} + {N}_{2} ) + 1 )}^{2} for {N}_{1} : odd , {N}_{2 ,} \frac{{N}_{2}}{2} : even , and$$

$${( 2 ( {N}_{1} {N}_{2} + {N}_{1} + {N}_{2} ) + 1 )}^{2} for {N}_{1} , \frac{{N}_{2}}{2} : odd , {N}_{2} : even .$$

FIG. 2A-FIG. 2D represent various schematic representations of sensor locations in the various antenna arrays. Conventionally, L-shaped arrays had been employed in DOA estimation. L-shaped arrays are two-dimensional arrays that have the shape of the letter “L”. The L-shaped arrays include two perpendicular lines, with one line longer than the other, forming a right angle. The L-shaped array may be modified by adding a third leg either at 450 between the other two legs or along one of the legs. In the present disclosure, the L-shaped array is modified by adding the third leg (third linear subarray 230) at 45° to form the billboard antenna array as shown in FIG. 2A or by extending one leg to form the T-shaped antenna array as shown in FIG. 2B. In an example, all the subarrays are 1D sparse arrays. The sparse arrays require fewer sensors or active elements than uniform linear arrays (ULAs) to realize a given aperture length. Hence, the sparse arrays provide huge savings in associated system costs (e.g., feed, power consumption, and radio frequency chains). In aspects of the present disclosure, the sparse arrays are coprime arrays, nested arrays or super nested arrays. Various antenna arrays are derived from the billboard antenna array and the T-shaped (rotated-T) antenna array shown in FIG. 2A and FIG. 2B, respectively. All ULAs are replaced in the billboard antenna array and the T-shaped (rotated-T) antenna array with a 1D sparse array, wherein the 1D sparse array is selected from the group including the coprime array, the nested array, and the super nested array, therefore forming six different configurations of antenna arrays. The ULAs of the billboard or T-shaped antenna arrays are identical within any of the different configurations of antenna arrays. The six antenna arrays of the present disclosure provide large DOF by exploiting the fourth-order difference coarray (FODC). In addition to extending the Cramer-Rao bound for the fourth-order coarray, closed-form expressions for sensor locations and the number of consecutive lags, or uniform DOF (uDOF), are derived for all six antenna arrays.

The maximum DOF is achieved when the coprime pairs N₁ and N₂ are selected as closely as possible. Additionally, the maximum DOF of the nested antenna array and the super nested antenna array is achieved in the present disclosure. All six antenna arrays yield improved uDOF as compared with the conventional arrays. The T-shaped nested antenna array has comparable uDOF while the conventional L-shaped nested array (ALNA) requires a very large aperture size. During experiments, the weight functions were also derived and examined. Each antenna array has constant weights values irrespective of the number of sensors, except for the nested-based structure. All six antenna arrays have promising performance for 2D-DOA estimation in the presence of mutual coupling compared with the state of the art.

The antenna array may be broadly divided into two types of antenna arrays, i.e., the billboard antenna array, and the T-shaped antenna array. Each type of antenna array is further divided into three types (coprime, nested and super nested). For realizing the coprime billboard antenna array, each subarray was replaced by the coprime array (see: P. P. Vaidyanathan and P. Pal, “Sparse Sensing with Co-prime Samplers and Arrays”, IEEE Trans. Signal Process., vol. 59, no. 2, pp. 573-586, 2011—incorporated herein by reference in its entirety). The coprime arrays include two uniform linear subarrays having N₁ and N₂ elements, where N₁ and N₂ are two coprime integers, and N₂>N₁. The elements of the subarray that has N₁ elements are spaced by N₂d, while the elements of the subarray that has N₂ elements are spaced by N₁d, with d being the minimum separation between any two elements which is set as half the wavelength λ/2. The set of sensor locations P_{c}, is given as the union of the two sets,

$${P}_{c} = \{ {N}_{1} {n}_{2} d \vert 0 \leq {n}_{2} \leq {N}_{2} - 1 \} ⋃ \{ {N}_{2} {n}_{1} d \vert 0 \vert \leq {n}_{1} \leq {N}_{1} - 1 \} \qquad ( 1 )$$

The coprime array has a total of N_{c}=N₁+N₂−1 sensors (one sensor is shared between the subarrays). FIG. 2C shows an example of coprime array with N₁=4 and N₂=5. The set of the elements of the billboard array is given as:

$${S}_{B} = {G}_{x} ⋃ {G}_{y} ⋃ {G}_{xy} , \qquad ( 2 )$$

$$where$$

$${G}_{x} = \{ ( nd , 0 ) \vert nd ∈ g \} \qquad ( 3 )$$

$${G}_{y} = \{ ( 0 , nd ) \vert nd ∈ g \} \qquad ( 4 )$$

$${G}_{xy} = \{ ( nd , nd ) \vert nd ∈ g \} \qquad ( 5 )$$

and the set g=P_{c} describes the linear array used to construct the 2D array. The total number of elements is given as N=3N_{c}−2=3(N₁+N₂−1)−2.

To generate the billboard nested antenna array, the coprime array is replaced by the nested array (see: P. Pal and P. P. Vaidyanathan, “Nested Arrays: A novel Approach to Array Processing with Enhanced Degrees of Freedom,” IEEE Trans. Signal Process., vol. 58, no. 8, pp. 4167-4181, 2010—incorporated herein by reference in its entirety). The nested array includes two collinearly placed subarrays with different interelement spacing. For example, the first linear subarray 210 has N₁ elements with interelement spacing of d. The second linear subarray 220 has N₂ elements, but with interelement spacing of (N₁+1)d. For the billboard nested antenna array, the set of sensor locations Pₙ is given as follows:

$${P}_{n} = \{ {n}_{1} d \vert 1 \leq {n}_{1} \leq {N}_{1} \} ⋃ \{ {n}_{2} ( {N}_{1} + 1 ) d \vert 1 \leq {n}_{2} \leq {N}_{2} \} \qquad ( 6 )$$

The nested antenna array has a total of Nₙ=N₁+N₂ sensors. FIG. 2D shows an example of the nested antenna array with N₁=4 and N₂=4. The 2D nested billboard antenna array is constructed in the same way using equations (2)-(5) by setting g=Pₘ, where Pₘ=(N₂(N₁+)−1)d−Pₙ. The nested antenna array is rotated by swapping the positions of the dense subarray and the sparse subarray to improve the DOF and reduce the mutual coupling. The total number of elements is N=3Nₙ−2=N=3(N₁+N₂)−2.

The super nested billboard antenna array is constructed using the super nested array (See: C. L. Liu and P. P. Vaidyanathan, “Super Nested Arrays: Linear Sparse Arrays With Reduced Mutual Coupling-Part I: Fundamentals,” IEEE Trans. Signal Process., vol. 64, no. 16, pp. 4203-4217, 2016, incorporated herein by reference in its entirety). The super nested array is a modified version of the nested array that significantly reduces mutual coupling by relocating some of the elements of the nested array. The super nested array is used to define the super nested billboard antenna array as in equations (2)-(5) with g=Pₛₙ, where Pₛₙ is the set of sensor locations of the super nested billboard antenna array. The super nested array with Nₛ elements can be constructed with N₁≥4 and N₂≥3, using the integer set S² defined above. Similar to the nested antenna array, the super nested antenna array has a total number of elements N=3Nₛ−2=N=3(N₁+N₂)−2, where Nₛ is the total number of sensors in the super nested array.

For realizing the T-shaped antenna array, three sparse arrays similar to the billboard antenna array were used, however the third leg 130 is located along the negative side of the X-axis, as shown in FIG. 2B. The set of elements in the T-shaped 2D array is given as:

$${S}_{T} = {G}_{x} ⋃ {G}_{y} ⋃ {G}_{- x} \qquad ( 7 )$$

where Gₓ and G_{y} are as defined in equations (3) and (4), respectively, and:

$${G}_{- x} = \{ - {n}_{d} , 0 ) \vert {n}_{d} ∈ g \} \qquad ( 8 )$$

To construct the coprime T-shaped antenna array, the nested T-shaped antenna array, and the super nested T-shaped antenna array, equations (7) and (8) are used with the set G being equal to P_{c}, Pₘ, and Pₛₙ, respectively. The total number of elements is the same as that of their equivalents using the billboard structures.

For estimating 2D-DOA, the antenna array 100 assumes that K uncorrelated signal sources are located in the far-field of the sensor array (antenna array 100). The K uncorrelated signal sources generate narrowband signals that impinge on the 2D antenna array 100. The k^{th} signal source has an azimuth angle θₖ∈[0, π] and an elevation angle ϕₖ∈[0, 2π]. The received signal at the output of the antenna array over Q samples or snapshots can be expressed as:

$$y ( t ) = A \overline{( θ} , {ϕ}^{↼} ) s ( t ) + n ( t ) , t = 1 , 2 , … , Q \qquad ( 9 )$$

where y(t)=[y₁(t), y₂(t), . . . , y_{N}(t)]^{T}, n(t)=[n₁(t), n₂(t), . . . , n_{N}(t)]^{T}, s(t)=[s₁(t),s₂(t), . . . s_{K}(t)]^{T}·[·]^{T} is the transpose operator, and A(θ̅, [symbol] )=[a( [symbol] ₁, [symbol] ₁), a( [symbol] ₂, [symbol] ₂), . . . , a( [symbol] _{K}, [symbol] _{K})] is the manifold matrix of size N×K, with aₖ( [symbol] ₖ, [symbol] ₖ) being a steering vector that has an element (nₓ, n_{y})∈S_{B} or S_{T} given by [symbol] , where

$${{ϕ}^{↼}}_{k} = \frac{d}{λ} sin {θ}_{k} cos {ϕ}_{k} and {{ϕ}^{↼}}_{i} = \frac{d}{λ} sin {θ}_{k} sin {ϕ}_{k}$$

are the normalized DOAs. The 2D-DOA estimation is based on a fourth-order cumulant matrix. The fourth-order cumulant matrix is a matrix that contains the fourth-order cumulant values of a set of random variables. Cumulants are statistical measures used to describe the higher-order moments of a probability distribution. The fourth-order cumulant matrix is given as:

$$\begin{matrix}{C}_{4} = E \{ ( Y ⊗ {Y}^{*} ) {( Y ⊗ {Y}^{*} )}^{H} \} - E \{ ( Y ⊗ {Y}^{*} ) \} E \{ {( Y ⊗ {Y}^{*} )}^{H} \} - E \{ Y {Y}^{H} \} ⊗ E \{ {( Y {Y}^{H} )}^{*} \} \\ = ( A ⊗ {A}^{*} ) {{C}_{S} ( A ⊗ {A}^{*} )}^{H} \\ = {A}^{`} {{C}^{`}}_{s} {{A}^{`}}^{H}\end{matrix} \qquad ( 10 )$$

where [·]* and [·]^{H} represent the complex conjugate and Hermitian operators, respectively, À=A ⊗A* with ⊗ being the Kronecker product, à( [symbol] ₖ, [symbol] ₖ)=a( [symbol] ₖ, [symbol] ₖ) ⊗a* [symbol] ₖ, [symbol] ₖ),À and Y=[y₁(t₁), y₂(t₂), . . . , y_{N}(t_{Q})] are matrices of size N²×K and N×Q, respectively, and Cₛ=diag[g₁, g₂, . . . , g_{K}] is a diagonal matrix with gₖ= [symbol] (sₖ(t),sₖ*(t),sₖ(t),sₖ*(t)) being the kurtosis of the kₜₕ source signal and [symbol] (·) denotes the cumulants operator. Vectorizing C₄ yields:

$$c = vec ( {C}_{4} ) = \overline{A} ρ , \qquad ( 11 )$$

where vec(·) is the vectorization operator which turns a matrix into a column vector, Ā=À⊗À* is a matrix of size N₄×K and ρ=[g₁, . . . , g_{K}]^{T}. The extended steering matrix, Ā, is a function of the FODC, which has a total of lᵤ unique lags (the number of unique entries in each column of Ă). The number of consecutive lags generated by the FODC is l_{c}<lᵤ. The measurements associated with the consecutive lags are extracted and sorted to form a vector as:

$$r = B ρ , \qquad ( 12 )$$

where B is a matrix of size l_{c}×K, with bᵢ( [symbol] ᵢ, [symbol] ᵢ) being a steering vector that has an element (n′ₓ,n′_{y}) ∈ [symbol] ₄ given by [symbol] [symbol] ₄ is the largest URA segment in the FODC. The URA array is formed by uniformly spacing the sensors in both the azimuth and elevation directions. URA provides better resolution in both azimuth and elevation. By considering the consecutive segment of virtual lags (largest symmetric URA around the origin), 2D-DOA estimation can be performed based on r using a 2D unitary ESPRIT algorithm. The 2D unitary ESPRIT algorithm is based on the principle of super-resolution and utilizes the unitary property of the signal subspace. By exploiting the mathematical structure of the data, the 2D unitary ESPRIT algorithm is able to provide accurate estimates of the DOA even in the presence of noise and interference.

In the presence of mutual coupling, the sensors are influenced by their neighboring elements, and equation (9) becomes Y=CA(θ̅ [symbol] ) S+N, where C is a mutual coupling matrix. The mutual coupling matrix can be approximated by a B-banded symmetric Toeplitz matrix. In an example, the B-banded symmetric Toeplitz matrix is a matrix where the only non-zero elements are those along diagonals that are at most B elements away from the main diagonal. Additionally, the B-banded symmetric Toeplitz matrix is symmetric which means that the matrix entries have a reflectional symmetry about the main diagonal. The mutual coupling matrix depends on a separation between the elements, defined as:

$${〈 C 〉}_{{n}_{1} , {n}_{2}} \{ \begin{matrix}c {‖ {n}_{1} - {n}_{2} ‖}_{2} , & {‖ {n}_{1} - {n}_{2} ‖}_{2} \leq B \\ 0 , & otherwise\end{matrix} , \qquad ( 13 )$$

where n₁,n₂∈ [symbol] , ∥·∥₂ is the l₂-norm of a vector, and c₀,c₁, . . . , c_{B} are the mutual coupling coefficients with 1=c₀>|c₁|>|c_{\sqrt{2}} . . . >|c_{B}|>|c_{B+1}|=0, where

$$\vert \frac{{c}_{l}}{{c}_{k}} \vert = \frac{l}{k} for l , k > 0 .$$

### EXAMPLES AND EXPERIMENTS

The following examples are provided to illustrate further and to facilitate the understanding of the present disclosure.

Various experiments were performed to compare several metrics with the 2D sparse antenna arrays. For example, the several metrics include but are not limited to a number of virtual lag locations, required aperture size, resolution, and mutual coupling. All six antenna arrays have closed-form expressions for antenna locations and achieved DOF.

During experiments, a plurality of performance measures were used to evaluate and compare the described antenna arrays. In an example, the plurality of performance measures includes a number of unique or consecutive lags in the FODC, an aperture size (D), and a weight function.

### First Experiment: Determining Aperture Size for Each Antenna Array

The objective of the first experiment was to find a defined aperture size for each of the six antenna arrays. Due to the use of sparse arrays instead of ULAs in each leg, the six antenna arrays require larger aperture size than the already existing billboard and T-shaped arrays. This gives higher estimation accuracy but increases at the physical size and space requirements. Expressions for the aperture size are summarized in table 1. Note that the aperture size of the T-shaped array is twice its counterpart using billboard structure. The nested and super nested structures have equal aperture.

TABLE 1
Aperture Size

| Array | | Aperture (D units) |
|---|---|---|
| Billboard | Coprime | N₁ (N₂ − 1) × N₁ (N₂ − 1) |
| | Nested | (N₁ + (N₂ − 1)(N₁ + 1)) × (N₁ + (N₂− 1)(N₁ + |
| | | 1)) |
| | Super | (N₁ + (N₂ − 1)(N₁ + 1)) × (N₁ + (N₂ − 1)(N₁ + |
| | Nested | 1)) |
| T-Shaped | Coprime | 2N₁(N₂ − 1) × N₁(N₂ − 1) |
| | Nested | 2(N₁ + (N₂ − 1)(N₁ + 1)) × (N₁ + (N₂ − 1)(N₁ + |
| | | 1)) |
| | Super | 2(N₁ + (N₂ − 1)(N₁ + 1)) × (N₁ + (N₂ − 1)(N₁ + |
| | Nested | 1)) |

### Second Experiment: Analyzing Degrees of Freedom and Difference Coarray

During the second experiment, it was observed that when 4th-order statistics for estimation was used, the number of unique elements in the FODC was directly related to the degrees of freedom DOF. The DOF is the maximum number of detectable uncorrelated sources. The DOF is significant for algorithms that exploit all the elements in the difference coarray even if it is not hole-free. If the algorithm requires continuous segments, then the number of consecutive lags is more significant. Various terms used in the present disclosure are defined as:
Difference Coarray: Let a 2D array be specified by a set S, the SODC, D, is the difference between sensor positions as:

$$D = \{ {n}_{1} - {n}_{2} \vert {n}_{1} , {n}_{2} ∈ S \} \qquad ( 14 )$$

The FODC, D₄, can be calculated by taking the differences between the virtual positions generated by the set D as:

$${D}_{4} = \{ {p}_{1} - {p}_{2} \vert {p}_{1} , {p}_{2} ∈ D \} \qquad ( 15 )$$

In other words, p₁=n₁−n₂ and p₂=n₃−n₄ for any arbitrary sensor locations n₁, n₂, n₃, n₄ ∈S. The 4th-order difference coarray can be rewritten as: D₄=p₁−p₂=(n₁−n₂)−(n₃−n₄)=(n₁+n₄)−(n₂+n₃), or D₄=(n₄−n₂)+(n₁−n₃). Therefore, the FODC is also equivalent to the difference coarray of the second order sum coarray or the sum coarray of the SODC. The number of unique lags, lᵤ, of the FODC is equal to the cardinality of D₄, that is lᵤ=|D₄|. On the other hand, the number of consecutive lags, l_{c}, is equal to the cardinality of U₄, that is l_{c}=|U₄|, where U₄ is the largest URA segment in the FODC. The variables lᵤ and l_{c} are also known as the DOF and the uDOF. Table 2 summarizes the number of virtual lags and the required apertures.

TABLE 2
Number of virtual lags and aperture

| | Billboard | | | T-shaped | | |
|---|---|---|---|---|---|---|
| | | | Super | | | Super |
| | Coprime | Nested | Nested | Coprime | Nested | Nested |
| lᵤ | 3,873 | 5,449 | 5,361 | 4,511 | 6,537 | 5,107 |
| l_{c} | 2,209 | 2,209 | 1,849 | 3,249 | 5,929 | 2,601 |
| D | 16 × 16 | 19 × 19 | 19 × 19 | 32 × 16 | 38 × 19 | 38 × 19 |

FIG. 3A-FIG. 3F represent the FODC for all six antenna arrays, where N₁=4 and N₂=5 for coprime case, and N₁=N₂=4 for both nested and super nested cases. Therefore, the total number of elements is N=22.

FIG. 3A illustrates a fourth-order difference coarray (FODC) representation 300 for the coprime billboard antenna array. As shown in FIG. 3A, triangular objects 302 represent the physical locations of the elements (sensors). Dots 304 represent the virtual lag locations. Note that each linear coprime subarray having triangular objects 302 is identical to the two other linear coprime subarrays.

FIG. 3B illustrates a FODC representation 310 for the coprime T-shaped antenna array. Triangular objects 312 represent the physical locations of the elements (sensors) in FIG. 3B. Dots 314 represent the virtual lag locations in FIG. 3B. Note that each linear coprime subarray having triangular objects 312 is identical to the two other linear coprime subarrays.

FIG. 3C illustrates a FODC representation 320 for the nested billboard antenna array. As shown in FIG. 3C, triangular objects 322 represent the physical locations of the elements (sensors). Dots 324 represent the virtual lag locations. Note that each linear nested subarray having triangular objects 322 is identical to the two other linear nested subarrays.

FIG. 3D illustrates a FODC representation 330 for the nested T-shaped antenna array. Triangular objects 332 represent the physical locations of the elements (sensors) in FIG. 3D. Dots 334 represent the virtual lag locations in FIG. 3D. Note that each linear nested subarray having triangular objects 332 is identical to the two other linear nested subarrays.

FIG. 3E illustrates a FODC representation 340 for the super nested billboard antenna array. As shown in FIG. 3E, triangular objects 342 represent the physical locations of the elements (sensors). Dots 344 represent the virtual lag locations. Note that each linear super nested subarray having triangular objects 342 is identical to the two other linear super nested subarrays.

FIG. 3F illustrates a FODC representation 350 for the super nested T-shaped antenna array. Triangular objects 352 represent the physical locations of the elements (sensors) in FIG. 3F. Dots 354 represent the virtual lag locations in FIG. 3F. Note that each linear super nested array having triangular objects 352 is identical to the two other linear super nested arrays.

Third experiment: Finding closed-form expressions for each antenna array

The objective of the third experiment was to find closed-form expressions for the maximum achievable uDOF. For a 1D coprime array, for example, the second order difference coarray (SODC) for the 1D coprime array has 2(N₁+N₂)−1 consecutive lags in the range of −(N₁+N₂−1):(N₁+N₂−1) and >N₁N₂ unique lags. These holes affect the FODC, though the structure guarantees that the FODC realizes at least −2(N₁+N₂−1): 2(N₁+N₂−1)=4(N₁+N₂)−3 consecutive lags. In case of nested and super nested arrays, the SODC and the FODC have−(N₁+1)N₂+1:(N₁+1)N₂−1=2N₂(N₁+1)−1 and −2(N₁+1)N₂+2:2(N₁+1)N₂−2=4 N₂ (N₁+1)−3 unique lags (all are consecutive), respectively.

In an example, only one array along any axis was considered during experiments for discussion and consideration of the FODC. The coprime array has 33 consecutive lags, while the nested array and the super nested array have 77 consecutive lags. An identical array along the negative side of the same axis, as in the T-shaped antenna arrays, was installed, therefore doubling the number of the elements. The number of the elements will be squared (defined as O(·²) meaning on the order of the elements squared) of if the identical arrays are placed across all axes. The coprime array of the present disclosure is configured to generate a large URA due to the contribution between the utilized three sparse arrays to form the billboard configuration or the T-shaped configuration.

Extensive analysis was conducted to derive closed-form expressions for the uDOF, l_{c}, of all six antenna arrays. The resultant FODCs all had symmetric URA around the origin. Thus, the process starts by finding the (x, y) coordinate of any virtual lag on one of the four corners within the resultant URA (generated by the FODC). Then an expression, X, was drafted for the coordinates for different cases of N₁ and N₂. This expression was confirmed by intensive simulation. After that, the expression was doubled and incremented by one to account for the zero axis, that was 2X+1. Finally, the result was squared to account for all consecutive lags as: (2X+1)².

Table 3 illustrates all closed-form expressions which are used to find the maximum achievable l_{c} or uDOF. Apart from super nested antenna array, the formulas are applicable for arbitrary N₁ and N₂, provided that the greatest common divisor (GCD) is 1, i.e., GCD (N₁, N₂)=1, and N₂>N₁ for coprime case. The expressions related to super nested antenna arrays are valid for the optimal selection of N₁ and N₂. When N₁ and N₂ are selected as close as possible in case of the coprime array, the maximum uDOF is achieved, similar to the 1D case.

TABLE 3
Derived formulas for l_{c} based on the billboard shape and the T-shaped shape

| | Config- | | |
|---|---|---|---|
| Shape | uration | uDOF | Condition |
| Bill- | Co- | (2(N₁N₂ + N₁) − 1)² | 2N₁ > N₂, N₁ > 2 |
| board | prime | (2(N₁N₂ − N₁ + N₂) − 1)² | N₁ = 2, N₂ = 3 |
| | | | 2N₁ < N₂ |
| | Nested | (2(N₁N₂ + N₁ + N₂) − 1)² | ∀N |
| | Super Nested | (2(N₁N₂ + 2N₁) − 1)² | ${N}_{1} , {N}_{2} : even , \frac{{N}_{1}}{2} , \frac{{N}_{2}}{2} : odd$ |
| | | ${( 2 ( {N}_{1} {N}_{2} + \frac{3}{2} {N}_{1} ) - 1 )}^{2}$ | ${N}_{1} , {N}_{2} , \frac{{N}_{1}}{2} , \frac{{N}_{2}}{2} : even$ |
| | | (2(N₁N₂ + N₂) + 1)² | N₁, N₂: odd |
| | | | ${N}_{1} : odd , {N}_{2 ,} \frac{{N}_{2}}{2} : even$ |
| | | | ${N}_{1} , \frac{{N}_{2}}{2} : odd , {N}_{2} : even$ |
| | | ${( 2 ( {N}_{1} {N}_{2} + \frac{3}{2} {N}_{1} ) - 1 )}^{2}$ | ${N}_{1} , \frac{{N}_{2}}{2} : even , {N}_{2} : odd$ |
| | | (2(N₁N₂ + 2N₁) + 1)² | ${N}_{1} : even , \frac{{N}_{1}}{2} , {N}_{2} : even$ |
| T- | Co- | (6N₂ − 1)² | N₁ = 2 |
| Shaped | prime | (2(N₁N₂ + N₁ + N₂) − 1)² | N₁ > 2 |
| | Nested | (4(N₁ N₂ + N₂) − 3)² | ∀N |
| | Super Nested | ${( 2 ( {N}_{1} {N}_{2} + \frac{5}{2} {N}_{1} ) - 1 )}^{2}$ | ${N}_{1} , {N}_{2} , \frac{{N}_{1}}{2} , \frac{{N}_{2}}{2} : even$ |
| | | (2(N₁N₂ + 2N₁) + N₂)² | ${N}_{1} , {N}_{2} : even , \frac{{N}_{1}}{2} , \frac{{N}_{2}}{2} : odd$ |
| | | | ${N}_{1} , \frac{{N}_{1}}{2} : even , {N}_{2} : odd$ |
| | | (2(N₁N₂ + 2N₁) + N₂ + 2)² | ${N}_{1} : even , \frac{{N}_{1}}{2} , {N}_{2} : odd$ |
| | | (2(N₁N₂ + 2N₁) + | N₁, N₂: odd |
| | | N₂ + 1)² | |
| | | | ${N}_{1} : odd , {N}_{2} , \frac{{N}_{2}}{2} : even$ |
| | | | ${N}_{1} , \frac{{N}_{2}}{2} : odd , {N}_{2} : even$ |

Table 3 illustrates that the coprime billboard antenna array has 0(4N₂⁴) uDOF, when N₁=N₂−1, that is 2N₁>N₂. On the other hand, if N₁=N₂−1 for N₁>2 (optimal selection) is substituted in the corresponding formula of the coprime T-shaped antenna array from table 3, the result is l_{c}=(2(N₂²+N₂)−3)². Therefore, the coprime T-shaped antenna array has 0 (4(N₂²+N₂)²) uDOF, which is larger than that of the billboard coprime array by 4N₂²(2N₂+1).

The nested and super nested antenna arrays realize maximum performance when N₁ and N₂ are selected as in the 1D case. That is

$${N}_{1} = {N}_{2} = \frac{{N}_{n}}{2}$$

if Nₙ is even, whereas

$${N}_{1} = \frac{{N}_{n} - 1}{2}$$

and

$${N}_{2} = \frac{{N}_{n} + 1}{2}$$

if Nₙ is odd. N₁ and N₂ are either equal or N₂=N₁+1. This is also applicable for super nested antenna arrays. The nested structures have one expression for any arbitrary N₁ and N₂, (refer table 3). The nested billboard antenna array and the nested T-shaped antenna array realize

$$O ( \frac{1}{4} {{N}_{n}^{2} ( {N}_{n} + 4 )}^{2} ) = O ( \frac{4}{3 {6}^{2}} {( N + 2 )}^{2} {( N + 14 )}^{2} ) uDOF and O ( {{N}_{n}^{2} ( {N}_{n} + 2 )}^{2} ) = O ( \frac{1}{{9}^{2}} {( N + 2 )}^{2} {( N + 8 )}^{2} )$$

uDOF, respectively, where the symbol O means “on the order of”.

There are different scenarios for the super nested antenna arrays, as showed in table 3. When N₁ is even and

$$\frac{{N}_{1}}{2}$$

N₂ are both odd (N and N_{S} are both odd), for the billboard antenna array, l_{c}=(2(N₁N₂+2N₁)+1)² and the billboard antenna array attains

$$O ( \frac{1}{4} {( {N}_{s} - 1 )}^{2} {( {N}_{s} + 5 )}^{2} ) = O ( \frac{1}{1 {8}^{2}} {( N + 2 )}^{2} {( N + 14 )}^{2} ) uDOF .$$

The super nested T-shaped antenna array has l_{c}=(2(N₁N₂+2N₁+N₂)+1)², when N₁, N₂:odd or N₁:odd, N₂,

$$\frac{{N}_{2}}{2}$$

even or N₁,

$$\frac{{N}_{2}}{2}$$

odd, N₂:even. The first condition implies even Nₛ and N,

$$so {l}_{c} = {( \frac{1}{2} ( {N}_{s}^{2} + 6 {N}_{s} ) + 1 )}^{2} .$$

When Nₛ and N are odd based on the other conditions, consequently

$${l}_{c} = {( \frac{1}{2} ( {N}_{s}^{2} + 6 {N}_{s} ) - 5 )}^{2} .$$

These were achieved by replacing N₁ and N₂ by a defined selection. The super nested-based structures attain

$$O ( \frac{1}{1 {8}^{2}} {( N + 2 )}^{2} {( N + 20 )}^{2} ) uDOF .$$

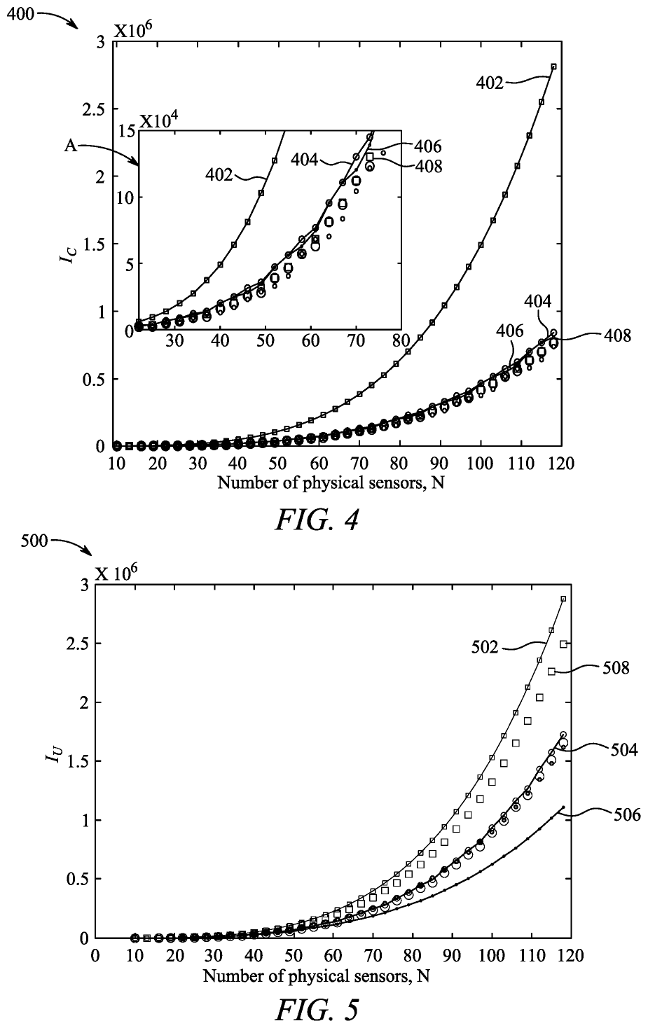

Considering the FODC, a comparison between the different billboard and T-shaped variants in terms of uDOF (l_{c}) and (l_{ug}), is illustrated in FIG. 4 and FIG. 5, respectively. An optimal conventional array (for example hourglass array) was used for all configurations. Specifically, N₁ and N₂ are selected as close as possible for coprime case and N₁=N₂=Nₙ/2 or

$${N}_{1} = \frac{{N}_{n} - 1}{2} and {N}_{2} = \frac{{N}_{n} + 1}{2}$$

if Nₙ is even or odd, respectively, for the nested and the super nested structures. The super nested array can be constructed for N₁≥4 and N₂≥3. Therefore, the traces in FIG. 4 and FIG. 5 start from N=3Nₛ−2=3(N₁+N₂)−2=22 elements, where Nₛ is the number of sensors of the super nested array. In case of coprime array (N₁=2, N₂=3) and nested (N₁=N₂=2) based structures, the traces start at N=10 elements.

FIG. 4 is an exemplary graph 400 illustrating a relationship of a number of consecutive lags (I) versus number of physical sensors (N). Curve 402 represents a number of physical sensors corresponding to uDOF in the nested T-shaped antenna array. Curve 404 represents a number of physical sensors corresponding to uDOF in the coprime T-shaped antenna array. Curve 406 represents a number of physical sensors corresponding to uDOF in the super nested T-shaped antenna array. Curve 408 represents a number of physical sensors corresponding to uDOF in the nested billboard antenna array. Window A represents a detailed view of the curves 402, 404, 406 and 408. As shown in FIG. 4, the coprime billboard antenna array, and the super nested T-shaped antenna array also approximately the same number of physical sensors as the nested billboard antenna array (curve 408).

The uDOF or number of consecutive lags versus the total number of elements, N, for all derived expressions in table 3 are shown in FIG. 4. All expressions were verified by simulation. The nested T-shaped antenna array achieves the largest number of consecutive lags. The coprime billboard antenna array and the nested billboard antenna array achieve a comparable performance. The coprime T-shaped antenna array and the super nested T-shaped antenna array also achieve comparable performance. The super nested billboard antenna array realizes the smallest number of consecutive lags among all configurations. Redistribution of the elements of the dense array is the main reason for reducing the mutual coupling.

FIG. 5 is an exemplary graph 500 illustrating a relationship of number of unique lags lᵤ, versus the number of physical sensors (N). Curve 502 represents a number of physical sensors versus the number of unique lags in the nested T-shaped antenna array. Curve 504 represents a number of physical sensors versus the number of unique lags in the coprime T-shaped antenna array. Curve 506 represents a number of physical sensors versus to the number of unique lags in the super nested T-shaped antenna array. Curve 508 represents a number of physical sensors versus the number of unique lags in the nested billboard antenna array. The coprime billboard antenna array and the super nested billboard antenna array have approximately the same number of unique lags to the coprime T-shaped antenna array (curve 504). As shown in FIG. 5, the T-shaped antenna arrays have larger lᵤ compared with the billboard antenna arrays, except for the super nested billboard antenna array. The graph of the nested T-shaped antenna arrays shows an improvement in sensor to lag performance in comparison with other configurations. Furthermore, the nested T-shaped antenna array has only a few holes.

As shown in FIG. 4, and FIG. 5, the traces of the nested structures are very close. These traces depend on mutual coupling and aperture size. The coprime billboard antenna array, the super nested billboard antenna array, and the coprime T-shaped antenna array achieve almost comparable performance. The super nested billboard antenna array realizes the smallest number of consecutive lags among all configurations (six antenna arrays).

### Fourth Experiment: Determining the Weight Function for Each Antenna Array

The objective of the fourth experiment was to determine the weight function for each of the antenna arrays. The weight function is a measure used to quantify the performance of the antenna arrays for DOA estimation in the presence of mutual coupling. It is well known that the effect of mutual coupling increases with the proximity of the sensors. The definition of the weight function of the difference coarray for 2D arrays is given by the following: Let a 2D array be specified by a set S, and let the SODC of the 2D array be D. The weight function of the difference coarray describes how many pairs of elements in S generate each element in D. In other words, how many sensor pairs in S are separated by mₓ and m_{y} in x and y directions, can be defined as:

$$w ( m ) = \vert \{ ( {n}_{1} , {n}_{2} ) ∈ {S}^{2} \vert {n}_{1} - {n}_{2} = m \} \vert \qquad ( 16 )$$

where |·|denotes the cardinality operation and m=(mₓ, m_{y}) is a vector of two components. The most significant weights that affect mutual coupling are the smallest ones. Particularly, w (0, 1), w (1, 0), w (1, 1), and w (1, −1) are the most important. In addition to increasing the distance between consecutive elements to reduce mutual coupling, the mutual impedance, which depends on the type of antennas, must be properly calibrated and computed.

From a mutual coupling perspective, the most significant weights in the 2D weight function are w (0, 1), w (1, 0), w (1, 1), and w (1, −1). Apart from the nested-based structure, the various antenna arrays as disclosed in the present disclosure offer significantly low values, see Table 4.

TABLE 4
2D weight function values

| | | | Billboard super | | T-shaped super | | |
|---|---|---|---|---|---|---|---|
| Structure | Billboard | T-shaped | nested | | nested | | Hourglass |
| Weight | coprime | coprime | Odd N₁ | Even N₁ | Odd N₁ | Even N₁ | array |
| w (1, 0) | 2 | 4 | 1 | 2 | 2 | 4 | 2 |
| w (0, 1) | 2 | 2 | 1 | 2 | 1 | 2 | {8 or 10} |
| w (1, 1) | 2 | 0 | 1 | 2 | 0 | 0 | {3, 5, 7, or 9} |
| w (1, −1) | 0 | 0 | 0 | 0 | 0 | 0 | {3, 5, 7, or 9} |

For the coprime billboard antenna array, the weight w (1,0) describes the number of elements spaced by 1 in x and 0 in y. The minimum spacing in the cross differences between any two legs is N₁, which is greater than 1. Therefore, the self-differences of the antennas for the leg that lies on the X-axis plays an important role in measuring weight function. The self-differences are measurements taken between antennas within the same linear subarray, taking two at a time and including all combinations. The 1D coprime array has only two pairs of sensors separated by d, i.e., w (1, 0)=2. The same argument holds true for the case of w (0, 1). However, the only contribution to this weight is from the self-differences generated by the y-axis leg. Therefore, w (0, 1)=2.

For w (1, 1) and to have a separation of 1 in x and y, the cross differences are all eliminated because the minimum separation between any two legs is N₁. Moreover, the self-differences of the legs laying on the x and y axes are eliminated as well, because they have either the same x or y coordinates. The only contribution left is from the self-differences of the third leg that lays on the x=y straight line. The elements in this leg have equal x and y coordinates. Therefore, if each coordinate is considered separately, then the 1D coprime array shows that this leg has 2 pairs of elements separated by d in x and y. Hence, w (1, 1)=2 and the overall spacing between the two elements is √2d.

Regarding w (1, −1), consider two elements and assume that the first element has less x coordinate value than the second element. The y coordinate of the first element must be greater than that of the second element to be counted in this weight. However, this is impossible because as x, y either increases, or stays unchanged, thus, w (1, −1)=0.

For the coprime T-shaped antenna array, it is considered that for the weight w (1, 0), the elements that generate this weight must have the same y coordinate. This is not possible except for elements on the x-axis. Therefore, the part of the array that lies on the y-axis does not contribute to this weight. Furthermore, the cross differences generated from the two legs that lie on the x-axis can be eliminated; because the minimum distance between the two legs that lie on the positive and negative x-axis, is N₁ which is greater than 1. The weight of the self-differences generated by each leg in the x-axis also contributes to the weight function. The 1D coprime array has only two pairs of sensors separated by d. Therefore, each leg on the x-axis will have 2 elements separated by (1, 0) and the whole 2D array will have w (1, 0)=4.

In similar manner, the weight for w (0, 1) may be calculated. For w (0, 1), the elements present on the x-axis do not contribute to the weight. Therefore, the only contribution is due to the leg that lies on the y-axis which results in a value of 2 for this weight, w (0, 1)=2. For w (1, 1), all elements in the T-shaped structure are either placed in the x or y axes. Moreover, the minimum distance between any two legs is N₁ which is greater than 1. Therefore, w (1, 1)=0. Regarding w (1, −1), a single leg cannot generate this weight because all legs lie on either x-axis or y-axis. Furthermore, the minimum distance between any two legs is N₁, N₁>1. Therefore, w (1, −1)=0.

For the nested billboard antenna array, the important values for the weight function are summarized in table 4. Only the self-differences generated from the elements within the dense subarray along the x-axis (subarray 1) contribute to w (1, 0), because the elements should have equal y coordinates. So w (1, 0)=N₁. Similarly, w (0, 1)=N₁. The self-differences generated form subarray 3 contribute to w (1, 1)=N₁. All self-differences generated from the three subarrays do not contribute to w (1, −1). This is because when the elements are separated by 1 in the x coordinates, they will be separated by 0 or 1 when subarray 1 or subarray 3 are considered, respectively. In addition, separation by 1 in y coordinates implies 0 separation in x coordinates in case of subarray 2, so w (1, −1)=0. The cross-differences do not contribute to any of these weights because the minimum spacing between the closest two elements in the three subarrays is (N₁+1)>1.

For the nested T-shaped antenna array, only the self-differences generated from the elements within the dense subarrays along the x-axis (subarray 1 (210) and subarray 3 (230)) contribute to w (1, 0), because the elements should have equal y coordinates. As a result, w (1, 0)=2N₁, and similarly w (0, 1)=N₁. The other two weights w (1, 1)=w (1, −1)=0 can be proven based on w (1, 0) or w (0, 1). If two elements are separated by 1 in x coordinates, then their separation in y coordinates become 0, not 1 or −1, and vice-versa. The cross-differences do not contribute to the separation because the minimum spacing between the closest two elements in the three subarrays is (N₁+1)>1.

A self-difference is defined as the difference between antennas within the same linear array, taking two at a time and including all combinations. The self-differences of each leg have a direct impact on w (0, 1), w (1, 0), w (1, 1), and w (1, −1), if n₂−n₁>1, where n₁ and n₂ are the locations of the first and second elements in each 1D subarray, respectively. In other words, the separation of the first two elements in each leg is greater than d. Using this, the weights may be written as:

For the billboard antenna arrays:

$$w ( 1 , 0 ) = n , w ( 0 , 1 ) = n , w ( 1 , 1 ) = n , w ( 1 , - 1 ) = 0$$

For the T-shaped antenna arrays:

$$w ( 1 , 0 ) = 2 n , w ( 0 , 1 ) = n , w ( 1 , 1 ) = 0 , w ( 1 , - 1 ) = 0$$

where n is the number of sensor pairs with a unit separation in the 1D leg.

The 1D super nested array has different weights for odd and even values of N₁. For odd N₁, w (1)=1. For even N₁, w (1)=2. The values for the super nested-based arrays and coprime-based arrays found in the simulation are presented in table 4. The values are compared to those achieved by the hourglass array. The antenna arrays of the present disclosure have small weights, except for w (1, 0). The nested array-based structures do not possess small nor constant values for the weight function due to the presence of the dense ULA segment in each leg.

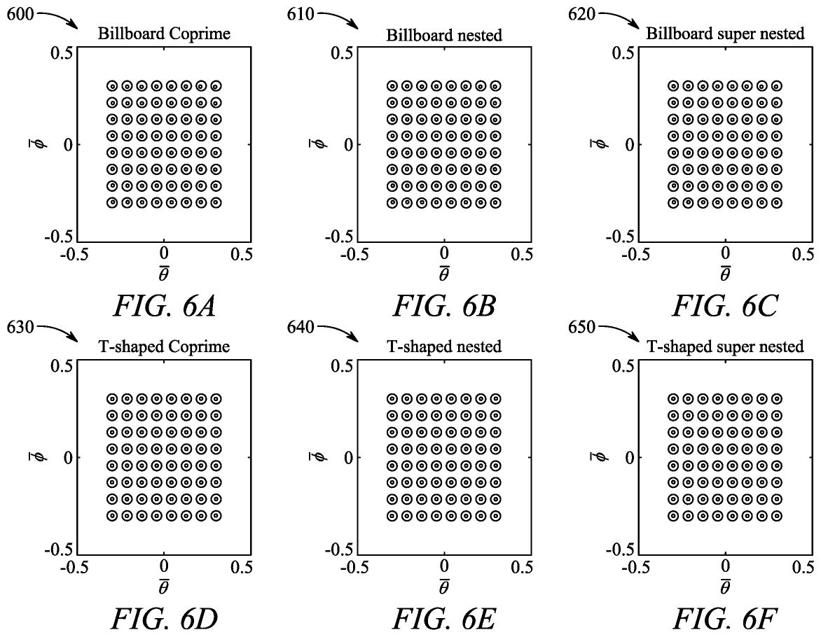

FIG. 6A-FIG. 6F represent the true source directions (in circles) and the estimated directions (in dots) for six antenna arrays with noise free, no mutual coupling, and Q=500 samples. Due to the large uDOF (see Table II), all arrays resolve all sources correctly. Note that the number of sources is larger than the number of sensors, K>N.

FIG. 6A is an illustration 600 of true source directions and the corresponding estimated directions for the coprime billboard antenna array.

FIG. 6B is an illustration 610 of true source directions and the corresponding estimated directions for the nested billboard antenna array.

FIG. 6C is an illustration 620 of true source directions and the corresponding estimated directions for the super nested billboard antenna array.

FIG. 6D is an illustration 630 of true source directions and the corresponding estimated directions for the coprime T-shaped antenna array.

FIG. 6E is an illustration 640 of true source directions and the corresponding estimated directions for the nested T-shaped antenna array.

FIG. 6F is an illustration 650 of true source directions and the corresponding estimated directions for the super nested T-shaped antenna array.

During experiments, the performance of six antenna arrays regarding 2D-DOA estimation were estimated based on the FODC with 2D unitary ESPRIT algorithm. The ESPRIT algorithm assumes that an antenna array is composed of two identical subarrays. The subarrays may overlap, that is, an array element may be a member of both subarrays. To carry out the estimation, only the central URA, U₄, contiguous part of D₄ is utilized by the ESPRIT algorithm. The number of snapshots is Q=500 and the SNR=0 dB. A total of K=4 uncorrelated sources are assumed, and their normalized direction-cosines are equally spaced without any rotation. For the experiments, it was assumed that the total number of elements of each array is N=22, with N₁=4 and N₂=5 for coprime, and N₁=N₂=4 for nested and super nested based structures. The mutual coupling parameters are c₁=0.3, B=5, and c₁=c₁/l e^{jπ(l-1)/4}. The root-mean-squared error (RMSE) is used to assess the performance, which combines both azimuth and elevation as:

$$RMSE = \sqrt{\frac{1}{K} {\sum }_{i = 1}^{I} {\sum }_{k = 1}^{K} {( {{θ}^{↼}}_{k} - {\hat{{θ}^{↼}}}_{k} ( i ) )}^{2} + {( {{ϕ}^{↼}}_{k} - {\hat{{θ}^{↼}}}_{k} ( i ) )}^{2}} \qquad ( 17 )$$

where [symbol] ₖ(i) and [symbol] ₖ(j) are the estimate of [symbol] ₖ and [symbol] ₖ, respectively, at the i^{th} Monte Carlo trial, i 1,2, . . . , I, and K is the number of sources to be localized. A total of Monte-Carlo trials I=100 were used. The Monte-Carlo trials are a computational technique used to approximate the outcomes of a probability distribution. By running a large number of random simulations, Monte Carlo trials can give an estimate of the likelihood of various outcomes. All these parameters were fixed unless otherwise stated.

To examine the achievable DOF, a total of K=64 sources were assumed in a noise free environment and in the absence of mutual coupling. FIG. 6A-FIG. 6F show the actual and the estimated cosine-directions marked in circles and dots, respectively.

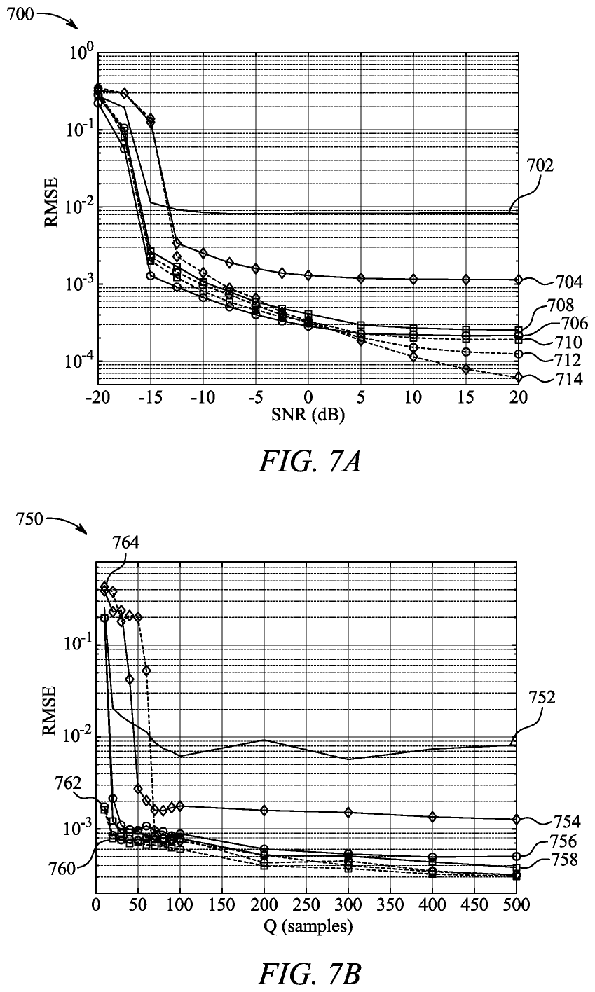

FIG. 7A-FIG. 7B show the RMSE of the estimated DOAs for the antenna arrays ignoring the effect of mutual coupling when K=4 sources. FIG. 7A is an exemplary graph 700 illustrating the RMSE of the estimated direction of arrivals (DOAs) without mutual coupling when signal-to-noise ratio (SNR) is varying. Curve 702 represents the RMSE for the hourglass array. Curve 704 represents the RMSE for the super nested billboard antenna array. Curve 706 represents the RMSE for the coprime billboard antenna array. Curve 708 represents the RMSE for the nested billboard antenna array. Curve 710 represents the RMSE for the nested T-shaped antenna array. Curve 712 represents the RMSE for the coprime T-shaped antenna array. Curve 714 represents the RMSE for the super nested T-shaped antenna array. The RMSE is calculated when the SNR is varying, and the number of snapshots is fixed as 500.

FIG. 7B is an exemplary graph 750 illustrating the RMSE of the estimated direction of arrivals (DOAs) without mutual coupling when SNR is fixed. In such case, the number of snapshots are varying, and SNR is 0 dB. Curve 752 represents the RMSE for the hourglass array. Curve 754 represents the RMSE for the super nested billboard antenna array. Curve 756 represents the RMSE for the coprime billboard antenna array. Curve 758 represents the RMSE for the nested billboard antenna array. Curve 760 represents the RMSE for the nested T-shaped antenna array. Curve 762 represents the RMSE for the coprime T-shaped antenna array. Curve 764 represents the RMSE for the super nested T-shaped antenna array.

An hourglass array was simulated using N=22 elements, with Nₓ=N_{y}=8. The hourglass array had a hole-free SODC and had good performance in the presence of mutual coupling. For fair comparison with the hourglass array, the FODC is considered which is also a hole-free coarray. The coarray has lᵤ=l_{c}=841 lags and the array required a 7d×7d aperture size. It is evident that the performance improved with the increase of SNR and number of samples. Due to their large uDOF, the T-shaped configuration realized smaller RMSE at high SNR when mutual coupling was ignored. All six antenna arrays attained smaller RMSE compared with the hourglass array. However, the hourglass array had a smaller aperture size.

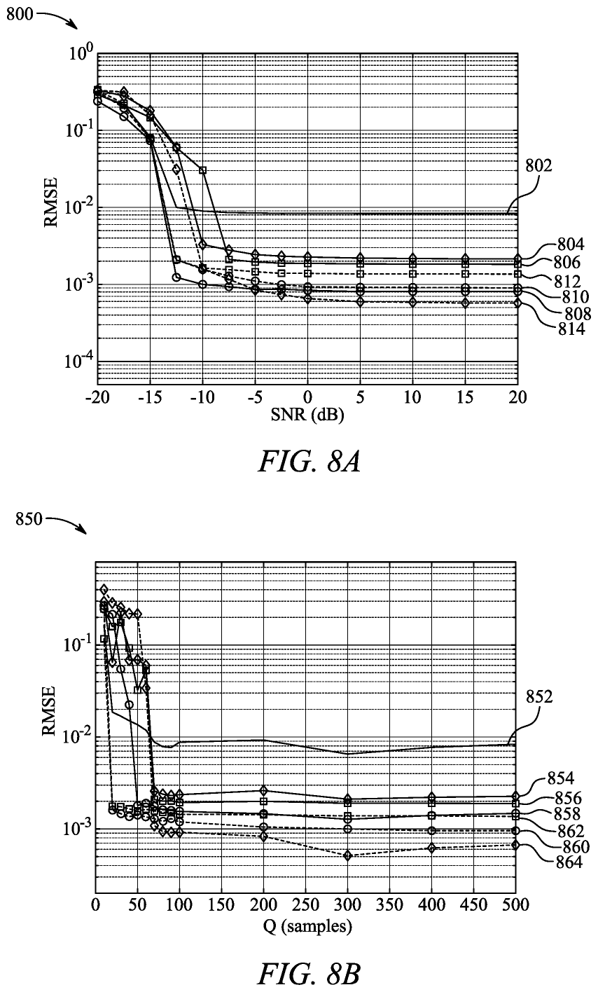

The effect of mutual coupling is illustrated in FIG. 8A-FIG. 8B.

FIG. 8A is an exemplary graph 800 illustrating the RMSE of the estimated DOAs with mutual coupling when the SNR was varied. Curve 802 represents the RMSE for the hourglass array. Curve 804 represents the RMSE for the super nested billboard antenna array. Curve 806 represents the RMSE for the nested billboard antenna array. Curve 808 represents the RMSE for the coprime billboard antenna array. Curve 810 represents the RMSE for the coprime T-shaped antenna array. Curve 812 represents the RMSE for the nested T-shaped antenna array. Curve 814 represents the RMSE for the super nested T-shaped antenna array. The antennas of the present disclosure show a clear performance enhancement as shown by the RMSE over the RMSE of the hourglass array.

FIG. 8B is an exemplary graph 850 illustrating the RMSE of the estimated DOAs with mutual coupling when SNR was fixed. Curve 852 represents the RMSE for the hourglass array. Curve 854 represents the RMSE for the super nested billboard antenna array. Curve 856 represents the RMSE for the nested billboard antenna array. Curve 858 represents the RMSE for the coprime billboard antenna array. Curve 860 represents the RMSE for the coprime T-shaped antenna array. Curve 862 represents the RMSE for the nested T-shaped antenna array. Curve 864 represents the RMSE for the super nested T-shaped antenna array.

Arrays based on the coprime and super nested antenna arrays illustrated greater robustness against mutual coupling as expected due to their sparseness, except for the billboard super nested antenna array. The billboard super nested antenna array had small uDOF as Table 2 depicted. As per the weights presented in table 4, the T-shaped super nested antenna array had the smallest RMSE. Although the T-shaped nested antenna array had the largest uDOF (see table 2), the mutual coupling deteriorated the performance of the T-shaped nested antenna array. Above 0 dB and around 300 samples, the mutual coupling became dominant, and the performance did not improve.

Since K is small, the impact of the mutual coupling is not significant. Increasing the number of sources made the mutual coupling effect clear and deteriorated the estimation capability of some arrays, despite the large number of consecutive lags. Although 2D sparse arrays may estimate K>N sources (see FIG. 6), the effect of mutual coupling makes the estimation process more challenging.

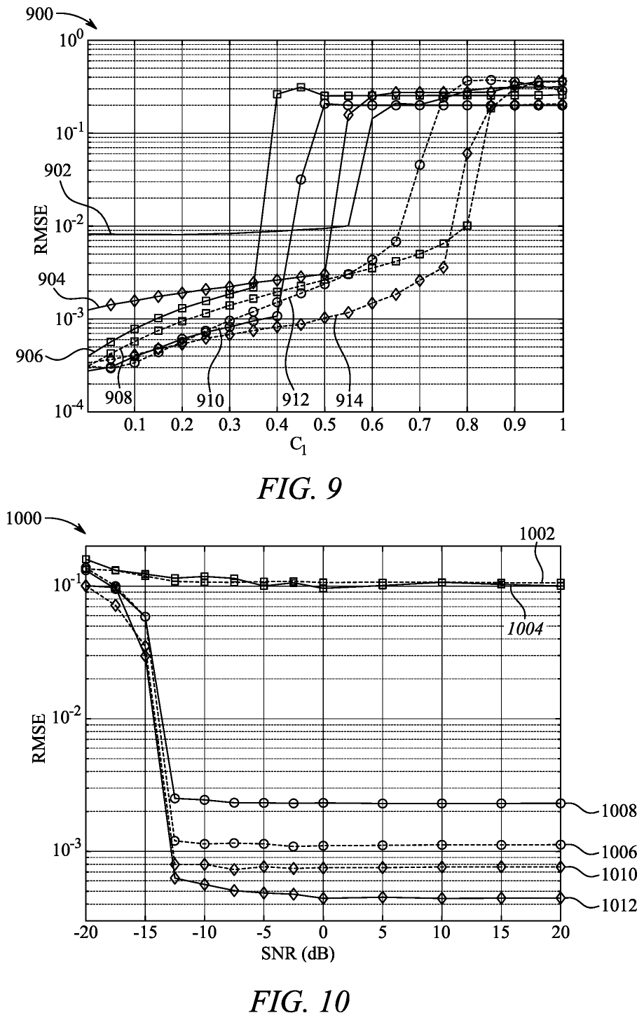

FIG. 9 is an exemplary graph 900 illustrating RMSE versus mutual coupling coefficient (c₁). Curve 902 represents the RMSE corresponding to the mutual coupling coefficient (c₁) for the hourglass array. Curve 904 represents the RMSE corresponding to the mutual coupling coefficient (c₁) for the super nested billboard antenna array. Curve 906 represents the RMSE corresponding to the mutual coupling coefficient (c₁) for the nested billboard antenna array. Curve 908 represents the RMSE corresponding to the mutual coupling coefficient (c₁) for the nested T-shaped antenna array. Curve 910 represents the RMSE corresponding to the mutual coupling coefficient (c₁) for the coprime billboard antenna array. Curve 912 represents the RMSE corresponding to the mutual coupling coefficient (c₁) for the coprime T-shaped antenna array. Curve 914 represents the RMSE corresponding to the mutual coupling coefficient (c₁) for the super nested T-shaped antenna array.

It is evident from FIG. 9 that the RMSE depends on c₁, the most significant coefficient in mutual coupling model, when SNR=0 dB, Q=500 samples, and K=4 sources. It can be concluded that the RMSE is small when c₁ is close to zero. The performance degraded above certain thresholds of c₁. These thresholds are the approximate values of c₁ at which the arrays can perform well in the presence of mutual coupling. FIG. 9 illustrates that the thresholds for the coprime billboard antenna array are around 0.4, 0.35 for the nested billboard antenna array, and 0.5 for the super nested billboard antenna array. The super nested billboard antenna array is more robust to mutual coupling effects than the other antenna arrays. The super nested billboard antenna array has also smaller uDOF as illustrated in Table 2. The thresholds for the coprime T-shaped antenna array are around 0.65, 0.8 for the nested T-shaped antenna array, and 0.75 for the super nested T-shaped antenna array. Although the nested based-structures have large mutual coupling, the large uDOF (see table 1) contributes to their performance in compensation. The T-shaped based structures realize larger uDOF and have larger aperture size. Compared with the state of art, the threshold is around 0.55 for the hourglass array. From experiments, it is evident that the T-shaped based structure is more robust to mutual coupling effects, where w (1, 0)=4, w (0, 1)=2, w (1, 1)=0, w (1,−1)=0 for the coprime array and the super nested array.

FIG. 4 was also used to compare arrays of similar or comparable uDOF. All configurations required comparable number of elements, except the T-shaped nested array. Configurations with comparable number of consecutive lags were further evaluated. Table 5 demonstrates that the closest billboard super nested array had large uDOF.

TABLE 5
Arrays of comparable uDOF with the required elements

| | Billboard | | | T-shaped | | |
|---|---|---|---|---|---|---|
| | Coprime | Nested | Super | Coprime | Nested | Super |
| l_{c} | 19,321 | 19,881 | 22,801 | 19,881 | 19,881 | 19,881 |
| N₁ | 7 | 7 | 8 | 7 | 5 | 7 |
| N₂ | 9 | 8 | 8 | 8 | 6 | 7 |
| N | 43 | 43 | 46 | 40 | 31 | 40 |

FIG. 10 is an exemplary graph 1000 illustrating the RMSE versus SNR with mutual coupling when number of sources (K)=25. Curve 1002 represents the RMSE corresponding to SNR for the nested T-shaped antenna array. Curve 1004 represents the RMSE corresponding to SNR for the nested billboard antenna array. Curve 1006 represents the RMSE corresponding to SNR for the coprime T-shaped antenna array. Curve 1008 represents the RMSE corresponding to SNR for the coprime billboard antenna array. Curve 1010 represents the RMSE corresponding to SNR for the super nested T-shaped antenna array. Curve 1012 represents the RMSE corresponding to SNR for the super nested billboard antenna array.

In the presence of mutual coupling, FIG. 10 shows the RMSE versus SNR with K=25 sources. In FIG. 10, only two Monte Carlo trials were used. Due to the mutual coupling effect, nested structures have the worst RMSE, while the best performance is realized by the super nested arrays.

The first embodiment is illustrated with respect to FIG. 1-FIG. 10. The first embodiment describes the antenna array 100 for reception of radio waves. The antenna array includes a first leg of antenna elements, wherein the first leg is aligned in a first direction; a second leg of antenna elements, wherein the second leg is aligned in a second direction orthogonal to the first direction; a third leg of antenna elements aligned in a third direction that is one of collinear with the first direction and at an angle of 45 degrees between the first direction and the second direction, wherein the first leg, the second leg and the third leg share a common vertex, and wherein the first leg, the second leg and the third leg are configured to receive the radio waves; wherein each of the first leg, the second leg and the third leg includes: a first linear subarray including N₁ antenna elements separated by a first distance; a second linear subarray including N₂ antenna elements separated by a second distance, wherein the first linear subarray and the second linear subarray are one of a set of coprime arrays, a set of nested arrays and a set of super nested arrays; and a communication module connected to the first leg, the second leg and the third leg, wherein the communication module comprises a receiver circuitry configured to determine a two dimensional direction of a source of the radio waves.

In an aspect, a minimum separation distance d between the antenna elements of the first leg, the second leg and the third leg is equal to one half of a minimum radio wavelength measurable by the antenna elements.

In an aspect, the antenna array is a coprime billboard antenna array in which the third leg 130 is aligned in a third direction that is at an angle of 45 degrees between the first direction and the second direction and the first linear subarray is coprime with the second linear subarray, where N₂>N₁, the first distance is equal to N₂d and the second distance is equal to N₁d.

In an aspect, an aperture size of the coprime billboard antenna array is given by: N₁(N₂−1) times N₁(N₂−1); and a total number N of antenna elements in the coprime billboard antenna array is given by: N=3(N₁+N₂−1)−2.

In an aspect, a maximum uniform number of degrees of freedom (uDOF) of the coprime billboard antenna array is given by: (2(N₁N₂+N₁)−1)² for 2N₁>N₂ and N₁>2, and (2(N₁N₂−N₁+N₂)−1)² for 2N₁<N₂.

In an aspect, the antenna array is a nested billboard antenna array in which the third leg is aligned in a third direction that is at an angle of 45 degrees between the first direction and the second direction, wherein the first distance is equal to d, and the second distance is equal to (N₁+1)d.

In an aspect, an aperture size of the nested billboard antenna array is equal to: ((N₁+(N₂−1) (N₁+1) times (N₁+(N₂−1) (N₁+1)), and a total number N of antenna elements in the nested billboard antenna array is given by: N=3(N₁+N₂)−2.

In an aspect, a maximum uniform number of degrees of freedom (uDOF) of the nested billboard antenna array is given by: (2(N₁N₂+N₁+N₂)−1)² for all N₁, N₂.

In an aspect, the antenna array is a super nested billboard antenna array in which the third leg is aligned in a third direction that is at an angle of 45 degrees between the first direction and the second direction, N₁≥4, N₂≥3, wherein the second linear subarray is specified by an integer set S² defined by:

$$\begin{matrix}{S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {Z}_{1}^{( 2 )} ⋃ {Z}_{2}^{( 2 )} , \\ {X}_{1}^{( 2 )} = \{ 1 + 2 l \vert 0 \leq l \leq {A}_{1} \} , \\ {Y}_{1}^{( 2 )} = \{ ( {N}_{1} + 1 ) - ( 1 + 2 l ) \vert 0 \leq 1 \leq {B}_{1} \} , \\ {X}_{2}^{( 2 )} = \{ ( {N}_{1} + 1 ) + ( 2 + 2 l ) \vert 0 \leq l \leq {A}_{2} \} , \\ {Y}_{2}^{( 2 )} = \{ 2 ( {N}_{1} + 1 ) - ( 2 + 2 l ) \vert 0 \leq l \leq {B}_{2} \} , \\ {Z}_{1}^{( 2 )} = \{ l ( {N}_{1} + 1 ) \vert 2 \leq l \leq {N}_{2} \} , \\ {Z}_{2}^{( 2 )} = \{ {N}_{2} ( {N}_{1} + 1 ) - 1 \} ,\end{matrix} \qquad ( 2 )$$

where l is an integer related to a dipole length of each of the antenna elements and A₁, B₁, A₂, and B₂ are parameters defined as:

$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r , r - 2 ) , & if {N}_{1} = 4 r + 2 \\ ( r , r , r , r - 1 ) , & if {N}_{1} = 4 r + 3\end{matrix}$$

where r is an integer.

In an aspect, an aperture size of the super nested billboard antenna array is equal to: ((N₁+(N₂−1) (N₁+1) times (N₁+(N₂−1) (N₁+1)), and a total number N of antenna elements in the super nested billboard antenna array is given by: N=3(N₁+N₂)−2.

In an aspect, a maximum uniform number of degrees of freedom (uDOF) of the super nested billboard antenna array is given by:

$$\begin{matrix}{( 2 ( {N}_{1} {N}_{2} + 2 {N}_{1} ) - 1 )}^{2} for {N}_{1} , {N}_{2} : even , \frac{{N}_{1}}{2} , \frac{{N}_{2}}{2} : odd , \\ {( 2 ( {N}_{1} {N}_{2} + \frac{3}{2} {N}_{1} ) - 1 )}^{2} for {N}_{1} , {N}_{2} , \frac{{N}_{1}}{2} , \frac{{N}_{2}}{2} : even , \\ {( 2 ( {N}_{1} {N}_{2} + {N}_{1} ) + 1 )}^{2} {N}_{1} , {N}_{2} : odd , \\ {( 2 ( {N}_{1} {N}_{2} + {N}_{1} ) + 1 )}^{2} for {N}_{1} : odd , {N}_{2} , \frac{{N}_{1}}{2} , \frac{{N}_{2}}{2} : even , \\ {( 2 ( {N}_{1} {N}_{2} + {N}_{1} ) + 1 )}^{2} for {N}_{1} , \frac{{N}_{2}}{2} : odd , {N}_{2} : even , \\ {( 2 ( {N}_{1} {N}_{2} + \frac{3}{2} {N}_{1} ) + 1 )}^{2} for {N}_{1} , \frac{{N}_{1}}{2} : even , {N}_{2} : odd , and \\ {( 2 ( {N}_{1} {N}_{2} + 2 {N}_{1} ) + 1 )}^{2} for {N}_{1} : even , \frac{{N}_{1}}{2} , {N}_{2} : odd .\end{matrix}$$

In an aspect, the antenna array is a coprime T-shaped antenna array in which the third leg is aligned in a third direction that is collinear with the first leg and opposite in direction to the first direction, wherein the first linear subarray is coprime with the second linear subarray, wherein N₂>N₁, and wherein the first distance is equal to N₂d and the second distance is equal to N₁d.

In an aspect, an aperture size of the coprime T-shaped antenna array is given by: (2(N₁+(N₂−1)(N₁+1)) times (N₁+(N₂−1)(N₁+1)), and a total number N of antenna elements in the coprime T-shaped antenna array is given by: N=3(N₁+N₂−1)−2.

In an aspect, a maximum uniform number of degrees of freedom (uDOF) of the coprime T-shaped antenna array is given by: (6N₂−1)² for N₁=2 and by (2(N₁N₂+N₁+N₂)−1)² for N₁>2.

In an aspect, the antenna array is a nested T-shaped antenna array in which the third leg is aligned in a third direction that is collinear with and opposite in direction to the first direction, wherein the first distance is equal to d, and the second distance is equal to (N₁+1)d.

In an aspect, an aperture size of the nested T-shaped antenna array is equal to: (2(N₁+(N₂−1) (N₁+1) times (N₁+(N2−1) (N₁+1)), and a total number N of antenna elements in the nested T-shaped antenna array is given by: N=3(N₁+N₂)−2.

In an aspect, a maximum uniform number of degrees of freedom (uDOF) of the nested T-shaped antenna array is given by: (4(N₁N₂+N₂)−3)₂ for all N₁, N₂.

In an aspect, the antenna array is a super nested T-shaped antenna array in which the third leg is aligned in a third direction that is collinear with and opposite in direction to the first direction, wherein N₁≥4, N₂≥3, and the second linear subarray is specified by an integer set S² defined by:

$$\begin{matrix}{S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {z}_{1}^{( 2 )} ⋃ {z}_{2}^{( 2 )} , \\ {X}_{1}^{( 2 )} = \{ 1 + 2 l \vert 0 \leq l \leq {A}_{1} \} , \\ {Y}_{1}^{( 2 )} = \{ ( {N}_{1} + 1 ) - ( 1 + 2 l ) \vert 0 \leq 1 \leq {B}_{1} \} , \\ {X}_{2}^{( 2 )} = \{ ( {N}_{1} + 1 ) + ( 2 + 2 l ) \vert 0 \leq l \leq {A}_{2} \} , \\ {Y}_{2}^{( 2 )} = \{ 2 ( {N}_{1} + 1 ) - ( 2 + 2 l ) \vert 0 \leq l \leq {B}_{2} \} , \\ {Z}_{1}^{( 2 )} = \{ l ( {N}_{1} + 1 ) \vert 2 \leq l \leq {N}_{2} \} , \\ {Z}_{2}^{( 2 )} = \{ {N}_{2} ( {N}_{1} + 1 ) - 1 \} ,\end{matrix}$$

where l is an integer related to a dipole length of each of the antenna elements and A₁, B₁, A₂, and B₂ are parameters defined as:

$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r , r - 2 ) , & if {N}_{1} = 4 r + 2 \\ ( r , r , r , r - 1 ) , & if {N}_{1} = 4 r + 3\end{matrix}$$

where r is an integer.

In an aspect, an aperture size of the super nested T-shaped antenna array is equal to: (2(N₁+(N₂−1) (N₁+1) times (N₁+(N₂−1) (N₁+1)), and a total number N of antenna elements in the super nested T-shaped antenna array is given by: N=3(N₁+N₂)−2.

In an aspect, a maximum uniform number of degrees of freedom (uDOF) of the super nested T-shaped antenna array is given by:

$$\begin{matrix}{( 2 ( {N}_{1} {N}_{2} + \frac{5}{2} {N}_{1} ) - 1 )}^{2} for {N}_{1} , {N}_{2} , \frac{{N}_{1}}{2} , \frac{{N}_{2}}{2} : even , \\ {( 2 ( {N}_{1} {N}_{2} + 2 {N}_{1} ) + {N}_{2} )}^{2} for {N}_{1} , {N}_{2} : even , \frac{{N}_{1}}{2} , \frac{{N}_{2}}{2} : odd , \\ {( 2 ( {N}_{1} {N}_{2} + 2 {N}_{1} ) + {N}_{2} + 2 )}^{2} for {N}_{1} : even , \frac{{N}_{1}}{2} , {N}_{2} : odd , \\ {( 2 ( {N}_{1} {N}_{2} + {N}_{1} + {N}_{2} ) + 1 )}^{2} for {N}_{1} , {N}_{2} ; odd , \\ {( 2 ( {N}_{1} {N}_{2} + {N}_{1} + {N}_{2} ) + 1 )}^{2} for {N}_{1} : odd , {N}_{2} , \frac{{N}_{2}}{2} : even , and \\ {( 2 ( {N}_{1} {N}_{2} + {N}_{1} + {N}_{2} ) + 1 )}^{2} for {N}_{1} , \frac{{N}_{2}}{2} : odd , {N}_{2} : even .\end{matrix}$$

Numerous modifications and variations of the present disclosure are possible in light of the above teachings. It is therefore to be understood that within the scope of the appended claims, the invention may be practiced otherwise than as specifically described herein.

1. An antenna array for reception of radio waves, comprising:
a first leg of antenna elements, wherein the first leg is aligned in a first direction;
a second leg of antenna elements, wherein the second leg is aligned in a second direction orthogonal to the first direction;
a third leg of antenna elements aligned in a third direction that is one of collinear with the first direction and at an angle of 45 degrees between the first direction and the second direction, wherein the first leg, the second leg and the third leg share a common vertex, and wherein the first leg, the second leg and the third leg are configured to receive the radio waves;
wherein each of the first leg, the second leg and the third leg includes:
a first linear subarray including N₁ antenna elements separated by a first distance;
a second linear subarray including N₂ antenna elements separated by a second distance, wherein the first linear subarray and the second linear subarray are one of a set of coprime arrays, a set of nested arrays and a set of super nested arrays; and
a communication module connected to the first leg, the second leg and the third leg, wherein the communication module comprises a receiver circuitry configured to determine a two dimensional direction of a source of the radio waves.

2. The antenna array of claim 1, wherein a minimum separation distance d between the antenna elements of the first leg, the second leg and the third leg is equal to one half of a minimum radio wavelength measurable by the antenna elements.

3. The antenna array of claim 2, wherein the antenna array is a coprime billboard antenna array in which the third leg is aligned in a third direction that is at an angle of 45 degrees between the first direction and the second direction and the first linear subarray is coprime with the second linear subarray, where N₂>N₁, the first distance is equal to N₂d and the second distance is equal to N₁d.

4. The antenna array of claim 3, wherein:
an aperture size of the coprime billboard antenna array is given by:
N₁(N₂−1) times N₁(N₂−1); and
a total number N of antenna elements in the coprime billboard antenna array is given by:
$$N = 3 ( {N}_{1} + {N}_{2} - 1 ) - 2 .$$

5. The antenna array of claim 4, wherein a maximum uniform number of degrees of freedom (uDOF) of the coprime billboard antenna array is given by:
$${( 2 ( {N}_{1} {N}_{2} + {N}_{1} ) - 1 )}^{2} for 2 {N}_{1} > {N}_{2} and {N}_{1} > 2 , and$$
$${( 2 ( {N}_{1} {N}_{2} - {N}_{1} + {N}_{2} ) - 1 )}^{2} for 2 {N}_{1} < {N}_{2} .$$

6. The antenna array of claim 2, wherein the antenna array is a nested billboard antenna array in which the third leg is aligned in a third direction that is at an angle of 45 degrees between the first direction and the second direction, wherein the first distance is equal to d, and the second distance is equal to (N₁+1)d.

7. The antenna array of claim 6, wherein:
an aperture size of the nested billboard antenna array is equal to:
((N₁+(N₂−1)(N₁+1) times (N₁+(N₂−1)(N₁+1)), and
a total number N of antenna elements in the nested billboard antenna array is given by:
$$N = 3 ( {N}_{1} + {N}_{2} ) - 2 .$$

8. The antenna array of claim 7, wherein a maximum uniform number of degrees of freedom of the nested billboard antenna array is given by:
$${( 2 ( {N}_{1} {N}_{2} + {N}_{1} + {N}_{2} ) - 1 )}^{2} for all {N}_{1} , {N}_{2} .$$

9. The antenna array of claim 2, wherein the antenna array is a super nested billboard antenna array in which the third leg is aligned in a third direction that is at an angle of 45 degrees between the first direction and the second direction, N₁≥4, N₂≥3, wherein the second linear subarray is specified by an integer set S² defined by:
$$\begin{matrix}{S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {z}_{1}^{( 2 )} ⋃ {z}_{2}^{( 2 )} , \\ {X}_{1}^{( 2 )} = \{ 1 + 2 l \vert 0 \leq l \leq {A}_{1} \} , \\ {Y}_{1}^{( 2 )} = \{ ( {N}_{1} + 1 ) - ( 1 + 2 l ) \vert 0 \leq 1 \leq {B}_{1} \} , \\ {X}_{2}^{( 2 )} = \{ ( {N}_{1} + 1 ) + ( 2 + 2 l ) \vert 0 \leq l \leq {A}_{2} \} , \\ {Y}_{2}^{( 2 )} = \{ 2 ( {N}_{1} + 1 ) - ( 2 + 2 l ) \vert 0 \leq l \leq {B}_{2} \} , \\ {Z}_{1}^{( 2 )} = \{ l ( {N}_{1} + 1 ) \vert 2 \leq l \leq {N}_{2} \} , \\ {Z}_{2}^{( 2 )} = \{ {N}_{2} ( {N}_{1} + 1 ) - 1 \} ,\end{matrix}$$
where l is an integer related to a dipole length of each of the antenna elements and A₁, B₁, A₂, and B₂ are parameters defined as:
$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r - 2 ) , & if {N}_{1} = 4 r + 2 \\ ( r , r , r , r - 1 ) , & if {N}_{1} = 4 r + 3\end{matrix}$$
where r is an integer.

10. The antenna array of claim 9, wherein:
an aperture size of the super nested billboard antenna array is equal to:
((N₁+(N₂−1)(N₁+1) times (N₁+(N₂−1)(N₁+1)), and
a total number N of antenna elements in the super nested billboard antenna array is given by:
$$N = 3 ( {N}_{1} + {N}_{2} ) - 2 .$$

11. The antenna array of claim 10, wherein a maximum uniform number of degrees of freedom of the super nested billboard antenna array is given by:
$$\begin{matrix}{( 2 ( {N}_{1} {N}_{2} + 2 {N}_{1} ) - 1 )}^{2} for {N}_{1} , {N}_{2} : even , \frac{{N}_{1}}{2} , \frac{{N}_{2}}{2} : odd , \\ {( 2 ( {N}_{1} {N}_{2} + \frac{3}{2} {N}_{1} ) - 1 )}^{2} for {N}_{1} , {N}_{2} , \frac{{N}_{1}}{2} , \frac{{N}_{2}}{2} : even , \\ {( 2 ( {N}_{1} {N}_{2} + {N}_{1} ) + 1 )}^{2} for {N}_{1} , {N}_{2} : odd , \\ {( 2 ( {N}_{1} {N}_{2} + {N}_{1} ) + 1 )}^{2} for {N}_{1} : odd , {N}_{2} , \frac{{N}_{1}}{2} , \frac{{N}_{2}}{2} : even , \\ {( 2 ( {N}_{1} {N}_{2} + {N}_{1} ) + 1 )}^{2} for {N}_{1} , \frac{{N}_{2}}{2} : odd , {N}_{2} : even , \\ {( 2 ( {N}_{1} {N}_{2} + \frac{3}{2} {N}_{1} ) + 1 )}^{2} for {N}_{1} , \frac{{N}_{1}}{2} : even , {N}_{2} : odd , and \\ {( 2 ( {N}_{1} {N}_{2} + 2 {N}_{1} ) + 1 )}^{2} for {N}_{1} : even , \frac{{N}_{1}}{2} , {N}_{2} : odd .\end{matrix}$$

12. The antenna array of claim 2, wherein the antenna array is a coprime T-shaped antenna array in which the third leg is aligned in a third direction that is collinear with the first leg and opposite in direction to the first direction, wherein the first linear subarray is coprime with the second linear subarray, wherein N₂>N₁, and wherein the first distance is equal to N₂d and the second distance is equal to N₁d.

13. The antenna array of claim 12, wherein:
an aperture size of the coprime T-shaped antenna array is given by:
(2(N₁+(N₂−1)(N₁+1)) times (N₁+(N₂−1)(N₁+1)), and
a total number N of antenna elements in the coprime T-shaped antenna array is given by:
$$N = 3 ( {N}_{1} + {N}_{2} - 1 ) - 2 .$$

14. The antenna array of claim 13, wherein a maximum uniform number of degrees of freedom of the coprime T-shaped antenna array is given by:
$${( 6 {N}_{2} - 1 )}^{2} for {N}_{1} = 2 and by {( 2 ( {N}_{1} {N}_{2} + {N}_{1} + {N}_{2} ) - 1 )}^{2} for {N}_{1} > 2 .$$

15. The antenna array of claim 2, wherein the antenna array is a nested T-shaped antenna array in which the third leg is aligned in a third direction that is collinear with and opposite in direction to the first direction, wherein the first distance is equal to d, and the second distance is equal to (N₁+1)d.

16. The antenna array of claim 15, wherein:
an aperture size of the nested T-shaped antenna array is equal to:
(2(N₁+(N₂−1)(N₁+1) times (N₁+(N₂−1)(N₁+1)), and
a total number N of antenna elements in the nested T-shaped antenna array is given by:
$$N = 3 ( {N}_{1} + {N}_{2} ) - 2 .$$

17. The antenna array of claim 15, wherein a maximum uniform number of degrees of freedom of the nested T-shaped antenna array is given by:
$${( 4 ( {N}_{1} {N}_{2} + {N}_{2} ) - 3 )}^{2} for all {N}_{1} , {N}_{2} .$$

18. The antenna array of claim 2, wherein the antenna array is a super nested T-shaped antenna array in which the third leg is aligned in a third direction that is collinear with and opposite in direction to the first direction, wherein N₁≥4, N₂≥3, and the second linear subarray is specified by an integer set S² defined by:
$$\begin{matrix}{S}^{2} = {X}_{1}^{( 2 )} ⋃ {Y}_{1}^{( 2 )} ⋃ {X}_{2}^{( 2 )} ⋃ {Y}_{2}^{( 2 )} ⋃ {z}_{1}^{( 2 )} ⋃ {z}_{2}^{( 2 )} , \\ {X}_{1}^{( 2 )} = \{ 1 + 2 l \vert 0 \leq l \leq {A}_{1} \} , \\ {Y}_{1}^{( 2 )} = \{ ( {N}_{1} + 1 ) - ( 1 + 2 l ) \vert 0 \leq 1 \leq {B}_{1} \} , \\ {X}_{2}^{( 2 )} = \{ ( {N}_{1} + 1 ) + ( 2 + 2 l ) \vert 0 \leq l \leq {A}_{2} \} , \\ {Y}_{2}^{( 2 )} = \{ 2 ( {N}_{1} + 1 ) - ( 2 + 2 l ) \vert 0 \leq l \leq {B}_{2} \} , \\ {Z}_{1}^{( 2 )} = \{ l ( {N}_{1} + 1 ) \vert 2 \leq l \leq {N}_{2} \} , \\ {Z}_{2}^{( 2 )} = \{ {N}_{2} ( {N}_{1} + 1 ) - 1 \} ,\end{matrix}$$
where l is an integer related to a dipole length of each of the antenna elements and A₁, B₁, A₂, and B₂ are parameters defined as:
$$( {A}_{1} , {B}_{1} , {A}_{2} , {B}_{2} ) = \{ \begin{matrix}( r , r - 1 , r - 1 , r - 2 ) , & if {N}_{1} = 4 r \\ ( r , r - 1 , r - 1 , r - 1 ) , & if {N}_{1} = 4 r + 1 \\ ( r + 1 , r - 1 , r - 2 ) , & if {N}_{1} = 4 r + 2 \\ ( r , r , r , r - 1 ) , & if {N}_{1} = 4 r + 3\end{matrix}$$
where r is an integer.

19. The antenna array of claim 18, wherein:
an aperture size of the super nested T-shaped antenna array is equal to:
(2(N₁+(N₂−1)(N₁+1) times (N₁+(N₂−1)(N₁+1)), and
a total number N of antenna elements in the super nested T-shaped antenna array is given by:
$$N = 3 ( {N}_{1} + {N}_{2} ) - 2 .$$

20. The antenna array of claim 19, wherein a maximum uniform number of degrees of freedom of the super nested T-shaped antenna array is given by:
$$\begin{matrix}{( 2 ( {N}_{1} {N}_{2} + \frac{5}{2} {N}_{1} ) - 1 )}^{2} for {N}_{1} , {N}_{2} , \frac{{N}_{1}}{2} , \frac{{N}_{2}}{2} : even , \\ {( 2 ( {N}_{1} {N}_{2} + 2 {N}_{1} ) + {N}_{2} )}^{2} for {N}_{1} , {N}_{2} : even , \frac{{N}_{1}}{2} , \frac{{N}_{2}}{2} : odd , \\ {( 2 ( {N}_{1} {N}_{2} + 2 {N}_{1} ) + {N}_{2} + 2 )}^{2} for {N}_{1} : even , \frac{{N}_{1}}{2} , {N}_{2} : odd , \\ {( 2 ( {N}_{1} {N}_{2} + {N}_{1} + {N}_{2} ) + 1 )}^{2} for {N}_{1} , {N}_{2} : odd , \\ {( 2 ( {N}_{1} {N}_{2} + {N}_{1} + {N}_{2} ) + 1 )}^{2} for {N}_{1} : odd , {N}_{2} , \frac{{N}_{2}}{2} : even , and \\ {( 2 ( {N}_{1} {N}_{2} + {N}_{1} + {N}_{2} ) + 1 )}^{2} for {N}_{1} , \frac{{N}_{2}}{2} : odd , {N}_{2} : even .\end{matrix}$$
